(19) United States
(12) Patent Application Publication
(10) Pub. No.: US 2026/0004372 A1
(43) Pub. Date: Jan. 1, 2026

(54) SYSTEM AND METHOD FOR NEAR-INSTANT UTILITY PATENT ALLOWANCE AND REJECTION VIA AI-POWERED LEGAL REASONING

(71) Applicant: Raj ABHYANKER, Mountain View, CA (US)

(72) Inventor: Raj ABHYANKER, Mountain View, CA (US)

(21) Appl. No.: 19/316,401

(22) Filed: Sep. 2, 2025

Related U.S. Application Data
(63) Continuation-in-part of application No. 18/199,908, filed on May 19, 2023, now Pat. No. 12,406,144.

(51) Int. Cl. G06Q 50/18; G06F 40/205

(52) U.S. Cl. CPC G06Q 50/184; G06F 40/205

(57) ABSTRACT

Disclosed is a system and/or a method for near-instant utility patent allowance and rejection via AI-powered legal reasoning. A computer-implemented method for near-instant evaluation of a utility patent application for an allowance and a rejection. The method includes receiving, by an artificial intelligence (AI) engine, an electronic submission of the utility patent application including at least one claim, a specification, one or more figures, and/or any associated oath and declaration.

### CLAIM OF PRIORITY

This Application is a Continuation-In-Part application of, and claims priority to, and incorporates by reference herein the entirety of the disclosure of co-pending U.S. patent application Ser. No. 18/199,908 titled-LINGUISTIC ANALYSIS TO AUTOMATICALLY GENERATE A HYPOTHETICAL LIKELIHOOD OF CONFUSION OFFICE ACTION USING DUPONT FACTORS filed on May 19, 2023; and

This Application is a Continuation-In-Part application of, and claims priority to, and incorporates by reference herein the entirety of the disclosure of co-pending U.S. patent application Ser. No. 19/296,951 titled-SYSTEM AND METHOD FOR NEAR-INSTANT TRADEMARK APPROVAL AND REJECTION VIA AI-POWERED LEGAL REASONING filed on Aug. 12, 2025.

### FIELD OF TECHNOLOGY

This disclosure relates generally to computer-implemented systems and methods for intellectual property management, and more specifically, to automated systems for reviewing submissions of new utility patent applications for intrinsic support and for patentability. The invention is situated at the intersection of artificial intelligence (AI), natural language processing (NLP), computer vision, and legal informatics, and provides a platform for automating trademark search, examination, conflict detection, specimen verification, and patent issuance workflows. The invention further pertains to the application of large language models (LLMs) and machine learning algorithms to simulate legal reasoning, generate patent allowance or rejection outcomes, and facilitate dispute resolution in the context of national and international patent law.

### BACKGROUND

The process of obtaining a utility patent may involve a lengthy, resource-intensive back-and-forth between applicants and the patent office. After an application is filed, patent examiners must identify and analyze relevant prior art, comparing each claim element to thousands of existing disclosures. This task requires both technical expertise and legal judgment, as examiners must assess novelty, non-obviousness, and compliance with statutory requirements. The initial examination often results in a rejection, not because the invention lacks merit, but because the claims require adjustment to distinguish over prior art or clarify ambiguities.

Following such an office action, applicants and their attorneys are required to prepare detailed responses, which may include claim amendments, legal arguments, and evidence of patentability. This exchange is iterative: examiners then evaluate the applicant's response, issue new rejections or objections, and the cycle continues. Each round requires careful legal and technical drafting, repeated review of the prior art, and close attention to procedural deadlines. The process not only consumes substantial attorney and examiner time but also imposes financial burdens on applicants, who may be individual inventors, startups, and/or large corporations alike.

Because of this extended back-and-forth, patent prosecution timelines frequently stretch over many years. During this period, applicants often face commercial uncertainty, as the scope and enforceability of their intellectual property rights remain unresolved. These delays can hinder investment, product launches, and strategic planning, particularly in fast-moving industries where technology rapidly evolves. Furthermore, the manual and human-driven nature of examination introduces variability in outcomes: similar inventions may receive different treatment depending on the examiner, art unit, and/or jurisdiction, leading to inconsistency and unpredictability across the system. In sum, the traditional prosecution process is marked by inefficiency, delay, and high resource consumption, straining the capacity of patent offices and creating barriers to timely, reliable protection for inventors.

### SUMMARY

Disclosed are a system and/or a method for near-instant utility patent allowance and rejection via AI-powered legal reasoning.

In one aspect, a computer-implemented method for near-instant evaluation of a utility patent application for an allowance or a rejection. The method includes receiving, by an artificial intelligence (AI) engine, an electronic submission of the utility patent application including at least one claim, a specification, one or more figures, and/or any associated oath and declaration.

The method includes interpreting, by the AI engine, each claim of the utility patent application by parsing each claim into individual limitations. Mapping each limitation to corresponding disclosure within the specification and/or the one or more figures. Determining whether intrinsic support exists within the specification (and/or the figures) for each limitation. Consulting a learned treatise and an authoritative reference in response to a determination that intrinsic support is insufficient and/or as further interpretation and understanding of the claims by the AI model (e.g., definition of a claim element needs further clarification).

The method includes evaluating, by the AI engine, statutory compliance of the utility patent application, including adjudicating compliance with 35 U.S.C. § 101 by confirming that the claimed subject matter pertains to statutory categories of patent-eligible subject matter in mechanical, electromechanical, pharmaceutical, and/or software domains. The method includes adjudicating compliance with 35 U.S.C. § 112 by determining whether the specification provides adequate written description, enablement sufficient for a person of ordinary skill in the art to make and use the invention (e.g., the claims). The method may also include disclosure of the best mode of practicing the invention. The method may verify consistency of figure numbering with corresponding textual descriptions in the specification. The method may detect antecedent basis errors within the claim, and inform the applicant when there are errors. The method may analyze a background section of the specification to detect admissions against interest that affect patentability of at least one claim.

The method includes conducting, by the AI engine, a prior art search across patent and non-patent literature databases to identify disclosure (e.g., sentences, paragraphs) in references most relevant to the at least one claim. The method includes determining, by the AI engine, whether disclosure in a single prior art reference anticipates each claim under 35 U.S.C. § 102. The method may include determining whether combinations of prior art references render the claims obvious under 35 U.S.C. § 103, includes through simulated claim construction and application of examiner guidelines from the Manual of Patent Examining Procedure (MPEP). The method may include determining whether at least one dependent claim contains limitations capable of being amended into independent form to overcome the rejection.

The method includes generating, by the AI engine, within a predetermined time less than one day (preferably in minutes), an output decision, includes an amendment proposing changes to the at least one claim, figures, and/or specification designed to place the utility patent application in condition for allowance, when the invention (e.g., an allowable claim) is determined to be patentable with the amendment, and generating a suggested acceptance of rewriting the dependent claim into independent form.

Incorporating limitations from the specification into the at least one claim when an applicant confirms. Narrowing the claim to be slightly narrower than a closest prior art while retaining support in the specification when suggesting the amendment.

The method may generate a written notice of allowance, when the invention (e.g., a claim) is determined to be allowable as filed. The method may generate a written rejection citing statutory grounds and identifying prior art references relied upon, when the invention (e.g., a claim) is determined to be unpatentable.

The method may include transmitting the generated output decision to an applicant, thereby enabling near-instant determination of the allowance and the rejection.

The method may include responsive to an agreement by the applicant to accept the output decision in which an examiner's amendment is proposed, automatically moving the utility patent application to the notice of allowance phase.

The computer-implemented method may further include the proposed examiner's amendment to automatically resolve antecedent basis errors by introducing proper referencing terms.

The computer-implemented method further includes the AI engine selects a dependent claim that includes non-obvious subject matter, and/or rewrites it into independent form to achieve allowance.

The computer-implemented method further includes the AI engine generates an annotated claim set displaying tracked changes, with inline references to supporting paragraphs in the specification.

The computer-implemented method further includes the AI engine proactively generates multiple alternative amendments, ranked by statistical confidence in allowability, for applicant selection.

The computer-implemented method further includes the proposed examiner's amendment may be designed to be just narrow enough to distinguish over the closest prior art, preserving maximum claim scope while placing the case in condition for the allowance.

The computer-implemented method further includes upon rejection, the AI engine proposes both a claim amendment option and a written rejection option, enabling the applicant to choose between acceptance of amendment for the allowance and/or submission of arguments in response.

The computer-implemented method further includes analyzing the utility patent application includes performing automated claim construction by using a natural language processing model to parse the claims and identify individual claim elements, determining the scope and meaning of each claim term based on a context provided by the specification and domain-specific definitions.

The computer-implemented method further includes the AI engine evaluates compliance with disclosure requirements by confirming that each claimed feature has corresponding support in the specification, thereby checking for enablement and/or written description sufficiency for the claims.

The computer-implemented method further includes the AI engine utilizes domain-specific knowledge bases and models during analysis, including models trained for mechanical and electromechanical inventions and models trained for software-related inventions, and/or automatically selects an appropriate model and knowledge base based on a technical field of the utility patent application to improve the accuracy of claim interpretation and prior art relevance.

The computer-implemented method further includes analyzing the patent application. Analyzing the patent application may further includes performing an automated prior art search by querying one or more patent and technical literature databases using at least one of keywords, semantic queries, and/or extracted features from the at least one claim and the specification, to retrieve relevant prior art references without human intervention.

The AI engine evaluates novelty of each claim by comparing the claim elements against the retrieved prior art references and determining whether disclosure in a single prior art reference describers all of the elements of a given claim, indicating a lack of novelty if such a reference may be found.

The computer-implemented further includes the AI engine evaluates non-obviousness by, in response to finding no single reference that anticipates the at least one claim, identifying combinations of two or more prior art references that collectively teach all elements of the claim and assessing whether the person of ordinary skill in the art would have been motivated to combine those references to arrive at the claimed invention.

The analysis applies patent examination guidelines for obviousness determinations, including analyzing the differences between the claimed invention and the prior art, considering the level of ordinary skill in the pertinent art, and/or applying established rationales to determine if there may be an apparent motivation to combine the prior art teachings, thereby ensuring the obviousness evaluation may be consistent with examiner standards.

The computer-implemented method further includes analyzing the utility patent application. Analyzing the patent application may further includes processing a submitted figures using computer vision techniques to identify at least one depicted component and process steps, and/or correlating those identified elements with the claim elements and prior art references to enhance the accuracy of the novelty and obviousness analysis for mechanical and electromechanical inventions.

The computer-implemented method further includes the output decision may be accompanied by a detailed explanation generated by the AI engine, the explanation including citations to the relevant prior art references for each claim limitation, an indication of any differences between the claimed invention and the prior art, and/or a rationale for at least one recommended allowance and rejection of each claim.

The computer-implemented further includes the AI engine leverages parallel processing and distributed computing to perform the analyzing step in subparts concurrently including claim parsing, prior art searching, and/or patentability rule application, such that the patentability determination may be completed within minutes of receiving the utility patent application, thereby achieving near-instant examination.

The computer-implemented method further includes the AI engine includes a legal reasoning engine, the legal reasoning engine may be trained on a corpus of patent examination data includes past patent applications, prior art citations, and/or examiner decisions, and may be periodically retrained using feedback from confirmed allowances and rejections, thereby continuously improving the accuracy and reliability of its allowance and rejection determinations over time.

In another aspect, a computer-implemented method oof near-instant evaluation of a utility patent application includes analyzing, using an artificial intelligence (AI) engine the utility patent application by interpreting the claims in view of the specification and the figures to identify support, consistency, and compliance with patentability criteria; evaluating, using the AI engine, patentability of the claims based at least in part on: (1) correspondence between the claims and the disclosure of the specification, and (2) relevance of prior art identified in one or more searchable databases; determining, by the AI engine, whether a claim of the utility patent application is any one of allowable, unallowable, and conditionally allowable with an amendment; and generating, using the AI engine any one of: a notice of allowance when the utility patent application is determined to be allowable as filed, a rejection decision identifying prior art and statutory grounds when the utility patent application is determined to be unallowable, and a proposed amendment designed to place the utility patent application in condition for allowance when the application is determined to be conditionally allowable. The method in this another aspect may train and periodically retrain the AI engine, on a corpus of patent examination data including past patent applications, prior art citations, and examiner decisions, using feedback from confirmed allowance and rejection decisions (e.g., or final rejection decisions) to continuously improve accuracy and reliability of the allowance and rejection determinations using the AI engine.

In yet another aspect, a system for near-instant evaluation of a utility patent application, includes a processor.

The system includes memory storing executable instructions that, when executed by the processor, configure the system to perform operations includes receiving, by an artificial intelligence (AI) engine, electronic data representing a utility patent application including a specification, at least one claim, and/or one or more figures. Analyzing the utility patent application by interpreting the claims in view of the specification and the figures to identify support, consistency, and/or compliance with patentability criteria. Leveraging parallel processing and distributed computing to perform said analyzing in concurrent subparts, including claim parsing, prior art searching, and/or application of patentability rules, such that evaluation is completed within minutes of receiving the utility patent application.

The system includes evaluating patentability of the claims based at least in part on correspondence between the claims and the disclosure of the specification. Relevance of prior art identified in one or more searchable databases. The system includes determining whether the utility patent application as filed is any one of allowable, unallowable, and/or conditionally allowable with amendment.

The system includes generating any one of a notice of allowance when the utility patent application is determined to be allowable as filed. A rejection decision identifying prior art and statutory grounds when the utility patent application is determined to be unallowable. A proposed amendment designed to place the utility patent application in condition for allowance when the application is determined to be conditionally allowable.

The system includes training and periodically retraining the AI engine on a corpus of patent examination data includes past patent applications, prior art citations, and/or examiner decisions, using feedback from confirmed allowances and rejections to continuously improve accuracy and reliability of allowance and rejection determinations.

The system further includes the proposed amendment generated by the AI engine includes a ranked set of alternative claim amendments, each alternative accompanied by (i) citations to specific supporting passages in the specification, (ii) an identification of the closest prior art reference distinguished by the amendment, and/or (iii) a quantified confidence score representing a probability of allowance if the amendment may be adopted.

The methods and systems disclosed herein may be implemented in any means for achieving various aspects, and may be executed in various forms, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a network view of a computer-implemented system for near-instant evaluation of a utility patent application, illustrating a processor, a memory, and an artificial intelligence (AI) engine configured to receive an electronic submission, according to one embodiment.

FIG. 2 is a block diagram of the computer-implemented system of FIG. 1 illustrating interpretation of a claim, a specification, and one or more figures by a natural language processing model, generating a determination, according to one embodiment.

FIG. 3 is a flow diagram illustrating automated prior art search and AI-based novelty/obviousness evaluation within an AI engine of a computer-implemented system of FIG. 1, according to one embodiment.

FIG. 4 is a block diagram of the computer-implemented system of FIG. 1 illustrating amendment generation and applicant interaction, including creation of proposed amendments, annotated claim sets, and ranked set of claim amendments for applicant acceptance or rejection, according to one embodiment.

FIG. 5 is a block diagram of the computer-implemented system of FIG. 1 illustrating output decision, with branching results including a notice of allowance, and a rejection decision, according to one embodiment.

FIG. 6 is a block diagram of the computer-implemented system of FIG. 1 illustrating a legal reasoning engine trained on a corpus of patent examination data with feedback loops and periodic retraining to improve allowance and rejection determination, according to one embodiment.

FIG. 7 is a user interface view illustrating auto-generation of draft claims of a utility patent application using an AI engine of the computer-implemented system of FIG. 1, according to one embodiment.

FIG. 8A is a user interface view illustrating submission of a utility patent application using an AI engine of the computer-implemented system of FIG. 1, according to one embodiment.

FIG. 8B is a user interface view illustrating amendments with suggested claims, and AI generated explanation using an AI engine of the computer-implemented system of FIG. 1, according to one embodiment.

FIG. 8C is a user interface view illustrating a rejection notification and analysis of claims with prior art references using the AI engine of the computer-implemented system of FIG. 1, according to one embodiment.

FIG. 9A-B is a process flow diagram of the computer-implemented system of FIG. 1 illustrating patent examination workflow to evaluate compliance of a utility patent application, according to one embodiment.

FIG. 10A-B is a process flow diagram of the computer-implemented system of FIG. 1 illustrating evaluation and decision-generation workflow of a utility patent application, according to one embodiment.

Other features of the present embodiments will be apparent from the accompanying drawings and from the detailed description that follows.

### DETAILED DESCRIPTION

Disclosed are a system and/or a method for near-instant utility patent allowance and rejection via AI-powered legal reasoning.

In one embodiment, a computer-implemented method for near-instant evaluation of a utility patent application 104 for an allowance and a rejection. The method includes receiving, by an artificial intelligence (AI) engine 124, an electronic submission 102 of the utility patent application 104 including at least one claim 108, a specification 106, one or more FIG. 110, and/or any associated oath 112 and declaration 114.

The method includes interpreting, by the AI engine 124, each claim 108 of the utility patent application 104 by parsing the at least one claim 108 into individual limitations. Mapping each limitation to corresponding disclosure within the specification 106 and/or the one or more FIG. 110. Determining whether intrinsic support exists within the specification 106 for each limitation. Consulting a learned treatise 224 and an authoritative reference 226 in response to a determination that intrinsic support is insufficient and/or a definition of a claim element needs further clarification.

The method includes evaluating, by the AI engine 124, statutory compliance of the utility patent application 104, including adjudicating compliance with 35 U.S.C. § 101 by confirming that the claimed subject matter pertains to statutory categories of patent-eligible subject matter in mechanical, electromechanical, and/or software domains. Adjudicating compliance with 35 U.S.C. § 112 by determining whether the specification 106 provides adequate written description 216, enablement sufficient for a person of ordinary skill in the art to make and use the at least one claim (e.g., invention), and/or disclosure of the best mode of practicing the invention. Verifying consistency of figure numbering with corresponding textual descriptions in the specification 218. Detecting antecedent basis errors 220 within the claim 108. Analyzing a background section 222 of the specification 106 to detect admissions against interest that affect patentability.

The method includes conducting, by the AI engine 124, a prior art search 126 across patent and non-patent literature databases 132 to identify disclosure (e.g., sentences, paragraphs) in references most relevant to the at least one claim 108. The method includes determining, by the AI engine 124, whether disclosure in a single prior art reference anticipates each claim 108 under 35 U.S.C. § 102 (lack of novelty 314). The method may include determining whether disclosure on combinations of prior art references render the claims obvious under 35 U.S.C. § 103 (apparent motivation 316), includes through simulated claim construction and application of examiner guidelines from the Manual of Patent Examining Procedure (MPEP). The method may include determining whether at least one dependent claim contains limitations capable of being amended into independent form to overcome a potential rejection.

The method includes generating, by the AI engine 124, within a predetermined time an output decision 138, includes an amendment proposing changes to the at least one claim 108, FIG. 110, and/or specification 106 designed to place the utility patent application 104 in condition for allowance, when the invention is determined to be patentable with the amendment, and a suggested acceptance 404 of rewriting the dependent claim into independent form 502. Incorporating limitations from the specification 106 into the at least one claim 108. Narrowing the claim 108 to be slightly narrower than a closest prior art 504 while retaining support in the specification 106. A notice of allowance 140, when the invention is determined to be allowable as filed. A written rejection 506 citing statutory grounds and identifying prior art references relied upon, when the invention is determined to be unpatentable.

The method includes transmitting the generated output decision 138 to an applicant 156, thereby enabling near-instant determination of the allowance and the rejection. The method includes responsive to an agreement by the applicant 156 to accept the output decision 138 in which an examiner's amendment is proposed, automatically moving the utility patent application 104 to the notice of allowance 140 phase.

The computer-implemented method further includes the proposed examiner's amendment automatically resolves antecedent basis errors 220 by introducing proper referencing terms. The computer-implemented method further includes the AI engine 124 selects a dependent claim that includes non-obvious subject matter, and/or rewrites it into independent form 502 to achieve allowance. The computer-implemented method further includes the AI engine 124 generates an annotated claim set 228 displaying tracked changes, with inline references to supporting paragraphs in the specification 106. The computer-implemented method further includes the AI engine 124 proactively generates multiple alternative amendments 146, ranked by statistical confidence in allowability (confidence score 152) and (probability of allowance 154), for applicant 156 selection.

The computer-implemented method further includes the proposed examiner's amendment may be designed to be just narrow enough to distinguish over the closest prior art 504, preserving maximum claim scope while placing the case in condition for the allowance. The computer-implemented method further includes upon rejection, the AI engine 124 proposes both a claim amendment option 402 and a written rejection option 506, enabling the applicant 156 to choose between acceptance of amendment for the allowance and/or submission of arguments in response 408.

The computer-implemented method further includes analyzing the utility patent application 104 includes performing automated claim construction by using a natural language processing model 202 to parse the claim(s) 108 and identify individual claim elements, determining the scope and meaning of each claim term based on a context 204 provided by the specification 106 and domain-specific definitions (knowledge base 208, technical field 210).

The computer-implemented method further includes the AI engine 124 evaluates compliance with disclosure requirements by confirming that each claimed feature has corresponding support in the specification 106, thereby checking for enablement and/or written description sufficiency 216 for the claim(s) 108. The computer-implemented method further includes the AI engine 124 utilizes domain-specific knowledge bases 208 and models 206 during analysis, including models trained for mechanical and electromechanical inventions and models trained for software-related inventions, and/or automatically selects an appropriate model 206 and knowledge base 208 based on a technical field 210 of the utility patent application 104 to improve the accuracy of claim interpretation and prior art relevance.

The computer-implemented method further includes analyzing the patent application 104. Analyzing the patent application 104 may further includes performing an automated prior art search 126 by querying one or more patent and technical literature databases 132 using at least one of keywords, semantic queries, and/or extracted features from the at least one claim 108 and the specification 106, to retrieve relevant prior art references without human intervention. The AI engine 124 evaluates novelty of each claim 108 by comparing the claim elements against the retrieved prior art references and determining whether disclosure in a single prior art reference discloses all of the elements of a given claim 108, indicating a lack of novelty 314 if such a reference may be found.

The computer-implemented further includes the AI engine 124 evaluates non-obviousness by, in response to finding no single reference that anticipates the claim 108, identifying combinations of two or more prior art references that collectively teach all elements of the claim 108 and assessing whether the person of ordinary skill in the art would have been motivated to combine those references to arrive at the claimed invention. The analysis applies patent examination guidelines for obviousness determinations, including analyzing the differences between the claimed invention and the prior art, considering the level of ordinary skill in the pertinent art, and/or applying established rationales to determine if there may be an apparent motivation 316 to combine the prior art teachings, thereby ensuring the obviousness evaluation may be consistent with examiner standards.

The computer-implemented method further includes analyzing the utility patent application 104. Analyzing the patent application 104 may further includes processing a submitted FIG. 110 using computer vision techniques to identify at least one depicted component and process steps, and/or correlating those identified elements with the claim elements 108 and prior art references to enhance the accuracy of the novelty 314 and obviousness 316 analysis for mechanical and electromechanical inventions.

The computer-implemented method further includes the output decision 138 may be accompanied by a detailed explanation 508 generated by the AI engine 124, the explanation 508 including citations 150 to the relevant prior art references for each claim limitation, an indication of any differences 510 between the claimed invention and the prior art 504, and/or a rationale 512 for at least one recommended allowance 140 and rejection 506 of each claim 108.

The computer-implemented further includes the AI engine 124 leverages parallel processing and distributed computing 604 to perform the analyzing step in subparts concurrently including claim parsing, prior art searching 126, and/or patentability rule application, such that the patentability determination may be completed within minutes of receiving the utility patent application 104, thereby achieving near-instant examination.

The computer-implemented method further includes the AI engine 124 includes a legal reasoning engine 602, the legal reasoning engine 602 may be trained on a corpus of patent examination data 136 includes past patent applications, prior art citations, and/or examiner decisions, and may be periodically retrained 606 using feedback from confirmed allowances/rejections 610, thereby continuously improving the accuracy and reliability of its allowance 140 and rejection 506 determinations over time.

In another embodiment, a computer-implemented method for near-instant evaluation of a utility patent application 104, includes receiving, by an artificial intelligence (AI) engine 124, electronic data representing the utility patent application 104 includes a specification 106, claims 108, and/or one or more FIG. 110.

The method includes analyzing, by the AI engine 124, the utility patent application 104 by interpreting the claims 108 in view of the specification 106 and the FIG. 110 to identify support, consistency, and/or compliance with patentability criteria.

The method includes leveraging parallel processing and distributed computing 604, by the AI engine 124, to perform said analyzing step in concurrent subparts, includes claim parsing, prior art searching 126, and/or application of patentability rules, such that the evaluation may be completed within minutes of receiving the utility patent application 104.

The method includes evaluating, by the AI engine 124, patentability of the claims 108 based at least in part on correspondence between the claims 108 and the disclosure of the specification 106. Relevance of prior art identified in one or more searchable databases 132.

The method includes determining, by the AI engine 124, whether at least one claim of the utility patent application 104 as filed is any one of allowable, unallowable, and/or conditionally allowable with an amendment.

The method includes generating, by the AI engine 124 any one of a notice of allowance 140 when the utility patent application 104 is determined to be allowable as filed. A rejection decision 506 identifying prior art and statutory grounds when the utility patent application 104 is determined to be unallowable. A proposed amendment 144 designed to place the utility patent application 104 in condition for allowance when the application is determined to be conditionally allowable.

The method includes training and periodically retraining the AI engine 124, on a corpus of patent examination data 136 including past patent applications, prior art citations, and/or examiner decisions, using feedback from confirmed allowance/rejection 610 to continuously improve accuracy and reliability of the allowance 140 and rejection 506 determinations.

The method includes transmitting any one of the notice of allowance 140, the rejection decision 506, and/or the proposed amendment 144 to an applicant 156, thereby enabling near-instant patent examination.

The method further includes, the proposed amendment 144 generated by the AI engine 124 includes a ranked set of alternative claim amendments 146, each alternative accompanied by (i) citations 150 to specific supporting passages in the specification 106, (ii) an identification 148 of the closest prior art reference 504 distinguished by the amendment, and/or (iii) a quantified confidence score 152 representing a probability of allowance 154 if the amendment may be adopted.

In yet another embodiment, a system for near-instant evaluation of a utility patent application, includes a processor 118.

The system includes memory 120 storing executable instructions that, when executed by the processor 118, configure the system to perform operations includes receiving, by an artificial intelligence (AI) engine 124, electronic data representing a utility patent application 104 including a specification 106, at least one claim 108, and/or one or more FIG. 110. Analyzing the utility patent application 104 by interpreting the claims 108 in view of the specification 106 and the FIG. 110 to identify support, consistency, and/or compliance with patentability criteria. Leveraging parallel processing and distributed computing 604 to perform said analyzing in concurrent subparts, including claim parsing, prior art searching 128, and/or application of patentability rules, such that evaluation is completed within minutes of receiving the utility patent application 104.

The system includes evaluating patentability of the claims 108 based at least in part on correspondence between the claims 108 and the disclosure of the specification 106. Relevance of prior art identified in one or more searchable databases 132. The system includes determining whether at least claim of the utility patent application 104 as filed is any one of allowable, unallowable, and/or conditionally allowable with amendment.

The system includes generating any one of a notice of allowance 140 when the utility patent application 104 is determined to be allowable as filed. A rejection decision 506 identifying prior art and statutory grounds when the utility patent application 104 is determined to be unallowable. A proposed amendment 144 designed to place the utility patent application 104 in condition for allowance when the application is determined to be conditionally allowable.

The system includes training and periodically retraining the AI engine 124 on a corpus of patent examination data 136 including past patent applications, prior art citations, and/or examiner decisions, using feedback from confirmed allowances and rejections 610 to continuously improve accuracy and reliability of allowance 140 and rejection 506 determinations.

The system further includes the proposed amendment 144 generated by the AI engine 124 includes a ranked set of alternative claim amendments 146, each alternative accompanied by (i) citations 150 to specific supporting passages in the specification 106, (ii) an identification 148 of the closest prior art reference 504 distinguished by the amendment, and/or (iii) a quantified confidence score 152 representing a probability of allowance 154 if the amendment may be adopted.

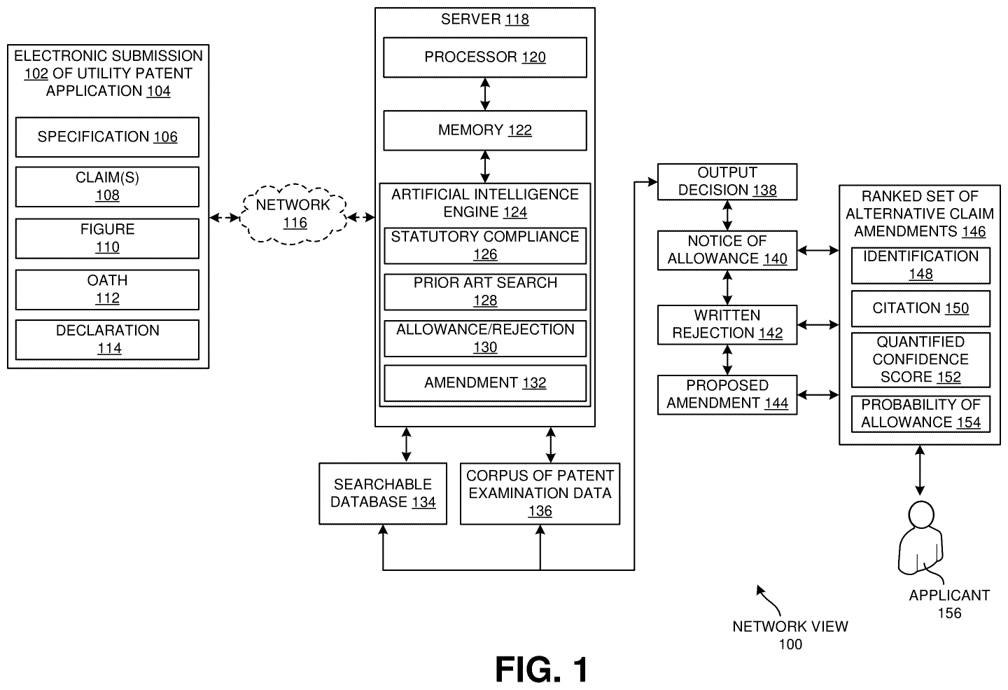

FIG. 1 is a network view 100 of a computer-implemented system for near-instant evaluation of a utility patent application 104, illustrating a processor 120, a memory 122, and an artificial intelligence (AI) engine 124 configured to receive an electronic submission 102, according to one embodiment. Particularly, FIG. 1 illustrates an electronic submission 102, a utility patent application 104, a specification 106, a claim(s) 108, FIG. 110, an oath 112, and a declaration 114, a network 116, a server 118, a processor 120, a memory 122, an artificial intelligence (AI) engine 124, a statutory compliance module 126, a prior art search module 128, an allowance/rejection module 130, an amendments module 132, a searchable database 134, a corpus of patent examination data 136, an output decision 138, a notice of allowance 140, a written rejection 142, a proposed amendment 144, a ranked set of alternative claim amendments 146, an identification 148, a citation 150, a quantified confidence score 152, a probability of allowance 154, and an applicant 156, according to one embodiment.

The electronic submission 102 may be a digital filing unit formatted for entry into a patent examination platform. The electronic submission 102 may be a structured digital package containing all documents required for filing the utility patent application 104. The electronic submission 102 may include text files, image files, and form data compliant with standardized filing systems, including XML-based EFS-Web and/or Patent Center formats. The electronic submission 102 may be configured to separate the specification 106, the claim(s) 108, the FIG. 110, the oath 112, and the declaration 114 into individually identifiable data components, ensuring machine readability and structured parsing by the AI engine 124, according to one embodiment.

The electronic submission 102 may be the entry point of the patent examination system. By providing a complete and organized dataset, the electronic submission 102 ensures no essential statutory element may be omitted, while also enabling the AI engine 124 to process each component independently, according to one embodiment.

The applicant 156 may upload the electronic submission 102 to the server 118 via the network 116. The AI engine 124 parses the submission, routing the specification 106 and the claims 106 to statutory compliance 126, the FIG. 108 to cross-mapping modules for intrinsic support, and the oath 112 and declaration 114 to verification subroutines. Once validated, the submission proceeds downstream for substantive examination, according to one embodiment.

The utility patent application 104 may be a statutory document required by the patent office for claiming exclusive rights in a new and useful process, machine, manufacture, and/or composition of matter. The utility patent application 104 may include the written specification 106, the one or more claim(s) 108, the FIG. 110, the oath 112, and the declaration 114. The utility patent application 104 may be represented digitally in a machine-readable format to allow the artificial intelligence engine 124 to process the submission, according to one embodiment.

The utility patent application 104 may provide the content for examination under patent laws. The utility patent application 104 may be reviewed by the statutory compliance module 126 to confirm eligibility under a subject matter eligibility 214 and a written description 216 requirements. The utility patent application 104 may also be reviewed by the prior art search module 128 to determine whether the claim(s) 108 may be novel under 35 U.S.C. § 102 and non-obvious under 35 U.S.C. § 103, according to one embodiment.

The utility patent application 104 may interact with the searchable database 134 and the corpus of patent examination data 136 through the artificial intelligence engine 124. The utility patent application 104 may ultimately lead to the generation of the output decision 138, which may result in the notice of allowance 140, the written rejection 142, and/or the proposed amendment 144, according to one embodiment.

The specification 106 may be a written description of the invention to supports the claim(s) 108. The specification 106 may include sections a background, a summary, a detailed description of embodiments, and/or references to the FIG. 110. The specification 106 may be structured in compliance with statutory matter eligibility 214 under 35 U.S.C. § 112 to provide a written description 216, enablement, and/or best mode, according to one embodiment.

The specification 106 may serve as the intrinsic evidence for evaluating whether each limitation of the claim(s) 108 may be adequately supported. The specification 106 may be parsed by the statutory compliance module 126 to identify support for claim terms, antecedent basis consistency, and disclosure adequacy. The specification 106 may also be cross-linked with the FIG. 110 to verify the structural and functional features adequately illustrated, according to one embodiment.

The specification 106 may be mapped to claim limitations during processing by the artificial intelligence engine 124. The specification 106 may also be used to generate citations 150 in support of proposed amendments 144 and to evaluate the probability of allowance 154. The specification 106 may provide the textual foundation for novelty and obviousness analysis conducted using the prior art search module 128 and the corpus of patent examination data 136, according to one embodiment.

The claim(s) 108 may be one or more formal legal statements defining the scope of protection sought in the utility patent application 104. The claim(s) 108 may be written in a structured format of preamble, transitional phrase, and body of limitations. The claim(s) 108 may serve as the legal boundary of the invention, distinguishing from the prior art. The claim(s) 108 may be structured into independent claims, which stand on their own, and dependent claim(s), which incorporate and refine the features of the independent claims, according to one embodiment.

The claim(s) 108 may be received within the artificial intelligence engine 124 as part of the electronic submission 102, along with the specification 106 and FIG. 110. The claim(s) 108 may be parsed and segmented by natural language processing 202 routines to identify individual limitations, which may then be mapped to supporting disclosure within the specification 106 and the FIG. 110. The claim(s) 108 may provide the central input to the statutory compliance module 126 for evaluation of a written description 216, enablement, and antecedent basis. The claim(s) 108 may also be compared against references retrieved from the searchable database 134 to assess novelty and obviousness. The claim(s) 108 may therefore direct the AI engine 124 toward assessing compliance with statutory law, according to one embodiment.

The FIG. 110 may be one or more visual drawings and/or diagrams included with the utility patent application 104 to graphically depict embodiments of the invention. The FIG. 110 may provide intrinsic evidence to support the claim(s) 108 and may establish a correlation between claimed subject matter and described embodiments. The FIG. 110 may also be reviewed for numbering consistency by the figure numbering consistency check 218, according to one embodiment.

The FIG. 110 may be processed by the artificial intelligence engine 124 to detect structural details, reference numerals, and alignments with the claim(s) 108. Any missing figure references and/or mismatches may be identified and reported in a compliance report 230. The FIG. 110 may also be cross-validated with the specification 106 to ensure each element disclosed in the claim(s) 108 has visual representation, according to one embodiment.

The FIG. 110 may further be incorporated into amendment proposals, where suggested modifications shown through tracked changes in an annotated claim set 228 and integrated with claim amendments 402. The FIG. 110 may therefore serve as a foundational element supporting novelty, enablement, and/or the written description 216 compliance, according to one embodiment.

The oath 112 may be a formal statement included with the utility patent application 104 in which the applicant 156 affirms to be the original inventor and/or an authorized representative. The oath 112 may be digitally submitted through the electronic submission 102 and verified by the statutory compliance module 126. The oath 112 may include legally binding declarations to establish the authenticity and accountability of the submission, according to one embodiment.

The oath 112 may be checked by the artificial intelligence engine 124 for completeness and compliance with procedural requirements. Missing and/or improperly worded content may be flagged, and corrective action may be proposed through a suggested acceptance 404 and/or claim amendment 402. The oath 112 may be stored as part of the overall compliance report 230 for confirmation during later examination stages, according to one embodiment.

The oath 112 may further act as a procedural trigger allowing subsequent modules of the artificial intelligence engine 124, including the allowance/rejection module 130 and the output decision 138, to proceed without procedural barriers. The oath 112 may therefore play a critical role in validating the legitimacy of the utility patent application 104, according to one embodiment.

The declaration 114 may be a supporting statement included alongside the oath 112 within the utility patent application 104. The declaration 114 may confirm all information provided may be accurate, complete, and in compliance with statutory requirements. The declaration 114 may serve as additional assurance to regulatory authorities that the submission meets baseline procedural standards, according to one embodiment.

The declaration 114 may be parsed and analyzed by the statutory compliance module 126 to confirm proper formatting and compliance with patent office requirements. The artificial intelligence engine 124 may also cross-check the declaration 114 against the background section 222 and learned treatise 224 to identify conflicts and/or admissions against interest. If discrepancies may be identified, the amendments module 132 may prepare the proposed amendment 144 to resolve issues, according to one embodiment.

The declaration 114 may therefore enable the artificial intelligence engine 124 to validate all procedural and formal requirements have been satisfied before generating the output decision 138. The declaration 114 may ultimately support issuance of the notice of allowance 140, the written rejection 142, and/or the proposed amendment 144, according to one embodiment.

The network 116 may be a digital communication infrastructure configured to transmit electronic data between the electronic submission 102, the server 118, and connected external data repositories. The network 116 may include public and private pathways such as the Internet, secure intranets, and encrypted communication channels. The network 116 may enable continuous data exchange to support real-time analysis of the utility patent application 104, according to one embodiment.

The network 116 may allow the electronic submission 102 to deliver the specification 106, claim(s) 108, FIG. 110, the oath 112, and the declaration 114 directly into the server 118 for processing. The network 116 may also route queries from the prior art search module 128 to the searchable database 134 and the corpus of patent examination data 136. Data returning from the repositories may then be reintegrated into the artificial intelligence engine 124 for interpretation and decision making, according to one embodiment.

The network 116 may therefore provide a seamless operational link between the applicant 156 and the artificial intelligence engine 124, ensuring timely processing within a predetermined time frame and enabling delivery of the output decision 138, according to one embodiment.

The server 118 may be a computing node configured to house the processor 120, the memory 122, and the artificial intelligence engine 124. The server 118 may operate as the centralized system executing every stage of near-instant examination of the utility patent application 104. The server 118 may support distributed and parallel processing through the parallel/distributed computing context 604, according to one embodiment.

The server 118 may manage execution of the statutory compliance module 126, the prior art search module 128, the allowance/rejection module 130, and the amendments module 132. Each of the modules may interact with the server 118 for coordinated computation. For example, the amendments module 132 may output a proposed amendment 144 and/or an annotated claim set 228, both of which may be delivered from the server 118 to the applicant 156 through the network 116, according to one embodiment.

The server 118 may therefore serve as the operational environment for implementing the computer-implemented method, while maintaining scalability, reliability, and compliance with patent examination requirements, according to one embodiment.

The processor 120 may be an integrated circuit designed to execute instructions associated with the artificial intelligence engine 124. The processor 120 may include one or more cores optimized for simultaneous multithreading, enabling concurrent execution of claim parsing, statutory analysis, and prior art searching. The processor 120 may leverage hardware acceleration for machine learning computations, including evaluation by the natural language processing model 202 and legal reasoning engine 602, according to one embodiment.

The processor 120 may coordinate tasks across modules by assigning resources dynamically. For example, when the prior art search module 128 initiates an automated prior art search 306 across the searchable database 134, the processor 120 may allocate computational capacity for query construction and retrieval analysis. At the same time, the processor 120 may assign parallel cores to the statutory compliance module 126 for verification of antecedent basis errors 220, according to one embodiment.

The processor 120 may therefore ensure the output decision 138 may be generated within a predetermined time, consistent with the requirements for near-instant patent examination, according to one embodiment.

The memory 122 may be a volatile and non-volatile storage medium configured to retain instructions and data for the artificial intelligence engine 124. The memory 122 may store intermediate parsing results of claim(s) 108, cross-references between the specification 106 and FIG. 110, and citations 150 to supporting passages. The memory 122 may also maintain libraries of trained models, including the appropriate model 206 and the knowledge base 208, according to one embodiment.

The memory 122 may serve as the central repository for information exchanged between modules. For example, the statutory compliance module 126 may deposit a compliance report 230 into the memory 122, while the amendments module 132 may store a ranked set of alternative claim amendments 146 with corresponding quantified confidence scores 152 and probabilities of allowance 154. The stored elements may then be retrieved for generation of the final output decision 138, according to one embodiment.

The memory 122 may therefore enable persistent storage and fast recall of every element necessary to execute the AI-driven patent evaluation pipeline, according to one embodiment.

The artificial intelligence engine 124 may be a computational framework operating on the processor 120 and memory 122 to execute advanced evaluation of the utility patent application 104. The artificial intelligence engine 124 may incorporate the natural language processing model 202, the legal reasoning engine 602, and the amendment generation features associated with claim amendment 402 and annotated claim set 228, according to one embodiment.

The artificial intelligence engine 124 may interpret the claim(s) 108 by parsing individual limitations and mapping them to the specification 106 and/or FIG. 110. The artificial intelligence engine 124 may further consult a learned treatise 224 and/or an authoritative reference 226 when intrinsic support may be missing. After interpretation, the artificial intelligence engine 124 may execute prior art searching, statutory compliance checks, and drafting of a proposed amendment 144, according to one embodiment.

The artificial intelligence engine 124 may therefore act as the core analytical element to integrates interpretation, validation, and amendment into a continuous flow, culminating in delivery of the output decision 138 to the applicant 156, according to one embodiment, according to one embodiment.

The statutory compliance module 126 may be a subsystem configured to evaluate provisions of patent law as applied to the utility patent application 104. The statutory compliance module 126 may include rule-based and model-based analyzers for 35 U.S.C. § 101 subject matter eligibility 214, § 112 written description 216, figure numbering consistency 218, antecedent basis errors 220, and background section 222 review. The statutory compliance module 126 may operate within the artificial intelligence engine 124 to ensure every claim 108 may be grounded in statutory requirements, according to one embodiment.

The statutory compliance module 126 may process parsed claim limitations from the natural language processing model 202 and compare each limitation against disclosures in the specification 106 and FIG. 110. When insufficiency may be detected, the statutory compliance module 126 may trigger consultation with a learned treatise 224 and/or authoritative reference 226. The compliance report 230 may then be generated and transferred to memory 122 for integration with downstream modules such as the allowance/rejection module 130, according to one embodiment.

The statutory compliance module 126 may therefore provide an automated compliance framework to reduces human error in examination and establishes a reliable input for the output decision 138, according to one embodiment.

The prior art search module 128 may be a subsystem configured to execute a prior art search 304 using automated prior art search 306 techniques. The prior art search module 128 may construct semantic, keyword, and feature-based queries derived from claim(s) 108, specification 106, and FIG. 110. The prior art search module 128 may then interrogate the searchable databases 134 and the corpus of patent examination data 136, according to one embodiment.

The prior art search module 128 may collect references 310 retrieved from external repositories and normalize the references into a format compatible with novelty determination 314 and obviousness determination 316. References identified by the prior art search module 128 may be stored in memory 122 and linked to citations 150 for later presentation in an annotated claim set 228 and/or a proposed amendment 144, according to one embodiment.

The prior art search module 128 may therefore enable the artificial intelligence engine 124 to identify novelty-destroying prior art and/or establish combinations of references forming an apparent motivation, both of which feed into the allowance/rejection module 130, according to one embodiment, according to one embodiment.

The allowance/rejection module 130 may be a subsystem configured to determine whether claim(s) 108 may be allowable, unallowable, and/or conditionally allowable. The allowance/rejection module 130 may analyze references 310 supplied by the prior art search module 128 and apply novelty 314 and obviousness 316 standards to generate a determination 212, according to one embodiment.

The allowance/rejection module 130 may produce three distinct outcomes. The first outcome may be a notice of allowance 140 generated when all claims 108 satisfy statutory requirements. The second outcome may be a written rejection 142 accompanied by citations 150 to references 310 when claims 108 may be anticipated and/or rendered obvious. The third outcome may be a proposed amendment 144 delivered to the amendments module 132 for conditional allowance. Each outcome may be stored in memory 122 for subsequent inclusion in the output decision 138, according to one embodiment.

The allowance/rejection module 130 may therefore transform analytical results from prior art and compliance checks into actionable decisions to proceed to amendment, acceptance, and/or rejection pathways, according to one embodiment.

The amendments module 132 may be a subsystem configured to draft modifications to claim(s) 108 and specification 106 in response to determinations from the allowance/rejection module 130. The amendments module 132 may generate a proposed amendment 144 to incorporates elements from the annotated claim set 228 and the claim amendment 402, according to one embodiment.

The amendments module 132 may also construct a ranked set of alternative claim amendments 146. Each alternative in the ranked set of alternative claim amendments 146 may include an identification 148, citations 150 to supporting passages in the specification 106, a quantified confidence score 152, and a probability of allowance 154. The applicant 156 may then review suggested acceptance 404 and/or request alternative amendments, according to one embodiment.

The amendments module 132 may therefore provide applicant-facing options for modification of claim(s) 108, ensuring efficient resolution of rejections while retaining maximum claim scope, according to one embodiment.

The searchable database 134 may be an external data repository accessible by the prior art search module 128 through the network 116. The searchable database 134 may include structured and unstructured data sets such as patent publications, non-patent literature, technical standards, and academic references. The searchable database 134 may support queries constructed by the automated prior art search 306 for rapid retrieval of references 310, according to one embodiment.

The searchable database 134 may deliver query results back to memory 122, where the results may be indexed against claim elements from claim(s) 108. When aligned with the corpus of patent examination data 136, the searchable database 134 may improve relevance ranking of prior art references 310. Citations 150 to the searchable database 134 may also be included in a detailed explanation 508 generated by the artificial intelligence engine 124, according to one embodiment.

The searchable database 134 may therefore serve as one of the principal external knowledge sources supporting novelty 314 and obviousness 316 determinations, according to one embodiment.

The corpus of patent examination data 136 may be a structured dataset of past applications, examiner decisions, and prosecution outcomes. The corpus of patent examination data 136 may serve as the primary training set for the legal reasoning engine 602, according to one embodiment.

The corpus of patent examination data 136 may provide precedent-based examples of how examiners determined lack of novelty 314 and/or apparent motivation 316 in prior cases. The data may be retrieved by the amendments module 132 when constructing a ranked set of alternative claim amendments 146, ensuring to each quantified confidence score 152 reflects historically validated patterns, according to one embodiment.

The corpus of patent examination data 136 may therefore enable the artificial intelligence engine 124 to continuously improve accuracy and reliability of allowance/rejection determinations through retraining process 606, according to one embodiment.

The output decision 138 may be a system-generated result summarizing the overall evaluation of the utility patent application 104. The output decision 138 may incorporate contributions from the statutory compliance module 126, the prior art search module 128, the allowance/rejection module 130, and the amendments module 132, according to one embodiment.

The output decision 138 may consist of one or more discrete documents including a notice of allowance 140, a written rejection 142, and/or a proposed amendment 144. When conditional amendments may be produced, the output decision 138 may also incorporate a ranked set of alternative claim amendments 146 with supporting evidence including citations 150, a quantified confidence score 152, and a probability of allowance 154, according to one embodiment.

The output decision 138 may therefore provide a comprehensive, applicant-facing conclusion to the automated examination cycle, according to one embodiment.

The notice of allowance 140 may be a system-generated authorization indicating the utility patent application 104 may be determined to meet statutory requirements without requiring further amendments. The notice of allowance 140 may be transmitted to the applicant 156 via the network 116 as part of the output decision 138, according to one embodiment.

The notice of allowance 140 may include references to statutory compliance findings stored in memory 122, thereby confirming the specification 106, claim(s) 108, and FIG. 110 satisfy requirements under 35 U.S.C. §§ 101 and 112. The notice of allowance 140 may also incorporate cross-references to the compliance report 230 generated by the statutory compliance module 126, according to one embodiment.

The notice of allowance 140 may therefore represent the most favorable endpoint for the applicant 156 and may proceed directly to issuance once formalities may be completed, according to one embodiment.

The written rejection 142 may be a system-generated communication indicating to one or more claim(s) 108 fail statutory and/or prior art requirements. The written rejection 142 may identify prior art references 310 retrieved by the prior art search module 128 and explain lack of novelty 314 and/or apparent motivation 316 findings, according to one embodiment.

The written rejection 142 may cite passages of the specification 106 where support may be lacking, highlight antecedent basis errors 220, and point to admissions found in the background section 222. The details may be presented as citations 150 in an annotated claim set 228 and/or in the detailed explanation 508 prepared by the artificial intelligence engine 124, according to one embodiment.

The written rejection 142 may therefore provide both legal and technical reasoning for non-allowance, serving as a foundation for applicant 156 to submit applicant arguments 408, according to one embodiment.

The proposed amendment 144 may be a draft document created by the amendments module 132 to place the utility patent application 104 in condition for allowance. The proposed amendment 144 may revise claim(s) 108 by incorporating language from the specification 106 and/or narrowing scope to distinguish over references 310, according to one embodiment.

The proposed amendment 144 may also appear alongside an annotated claim set 228, claim amendment 402, and suggested acceptance 404. Each proposed amendment 144 may be associated with quantified confidence scores 152 and probabilities of allowance 154 derived from the corpus of patent examination data 136, according to one embodiment.

The proposed amendment 144 may therefore serve as a conditional allowance pathway when direct allowance may be not available, according to one embodiment.

The ranked set of alternative claim amendments 146 may be a collection of multiple amendment options generated by the amendments module 132. Each alternative in the ranked set of alternative claim amendments 146 may be tagged with an identification 148, citations 150, a quantified confidence score 152, and a probability of allowance 154, according to one embodiment.

The ranked set of alternative claim amendments 146 may be presented to the applicant 156 through the user interface view 800. The applicant 156 may review plain-English explanations of differences between claim versions and select an amendment for submission. Each ranked set of alternative claim amendments 146 may also include an option to request further alternatives, directing the process back to the amendments module 132, according to one embodiment.

The ranked set of alternative claim amendments 146 may therefore offer applicants flexibility to balance scope retention and allowance probability, according to one embodiment.

The identification 148 may be a machine-assigned tag linked to a particular amendment, reference, and/or compliance issue. The identification 148 may allow the artificial intelligence engine 124 to track claim evolution across multiple iterations, according to one embodiment.

The identification 148 may also serve as a metadata key for citations 150, confidence scores 152, and probabilities of allowance 154. When stored in memory 122, the identification 148 may provide a stable reference for generating the final output decision report 514, according to one embodiment.

The identification 148 may therefore ensure traceability and auditability of every amendment and/or rejection decision within the AI-driven examination process, according to one embodiment.

The citation 150 may be a reference pointer connecting a claim limitation, amendment, and/or rejection reason to a supporting authority. The citation 150 may originate from the specification 106, prior art references 310, a learned treatise 224, and/or an authoritative reference 226, according to one embodiment.

The citation 150 may appear inline within the annotated claim set 228, the claim amendment 402, and/or the detailed explanation 508. Each citation 150 may provide evidence supporting allowance and/or rejection determinations generated by the allowance/rejection module 130, according to one embodiment.

The citation 150 may therefore serve as the factual and legal grounding for every decision delivered in the output decision 138, according to one embodiment.

The quantified confidence score 152 may be a numerical value generated by the artificial intelligence engine 124 to quantify the likelihood a proposed amendment 144 and/or ranked set of alternative claim amendments 146 will result in allowance. The quantified confidence score 152 may be derived from statistical modeling over the corpus of patent examination data 136, according to one embodiment.

The quantified confidence score 152 may be displayed in applicant-facing outputs. Each quantified confidence score 152 may help the applicant 156 evaluate whether to accept a suggested amendment and/or request alternatives, according to one embodiment.

The quantified confidence score 152 may therefore provide a transparent metric to supports applicant decision-making, according to one embodiment.

The probability of allowance 154 may be a predictive metric associated with a proposed amendment 144 and/or ranked set of alternative claim amendments 146. The probability of allowance 154 may represent the model-estimated chance to the USPTO would grant the utility patent application 104 with the selected amendments, according to one embodiment.

The probability of allowance 154 may be presented alongside confidence scores 152, citations 150, and identifications 148 in the final output decision report 514. The probability of allowance 154 may also be adjusted dynamically during retraining process 606 using feedback from confirmed allowances and rejections 610, according to one embodiment.

The probability of allowance 154 may therefore guide the applicant 156 in choosing among amendment options with varying degrees of risk, according to one embodiment.

The applicant 156 may be the entity submitting the utility patent application 104 through the electronic submission 102. The applicant 156 may upload documents, review amendments, and/or receive decisions, according to one embodiment.

The applicant 156 may interact with the output decision 138 by accepting a notice of allowance 140, reviewing a written rejection 142, and/or selecting among a ranked set of alternative claim amendments 146. Plain-English explanations may be provided to the applicant 156 to ensure accessibility to users without legal training, according to one embodiment.

The applicant 156 may therefore complete the feedback loop of the computer-implemented method by selecting outcomes, providing agreement, and/or submitting further arguments for review, according to one embodiment.

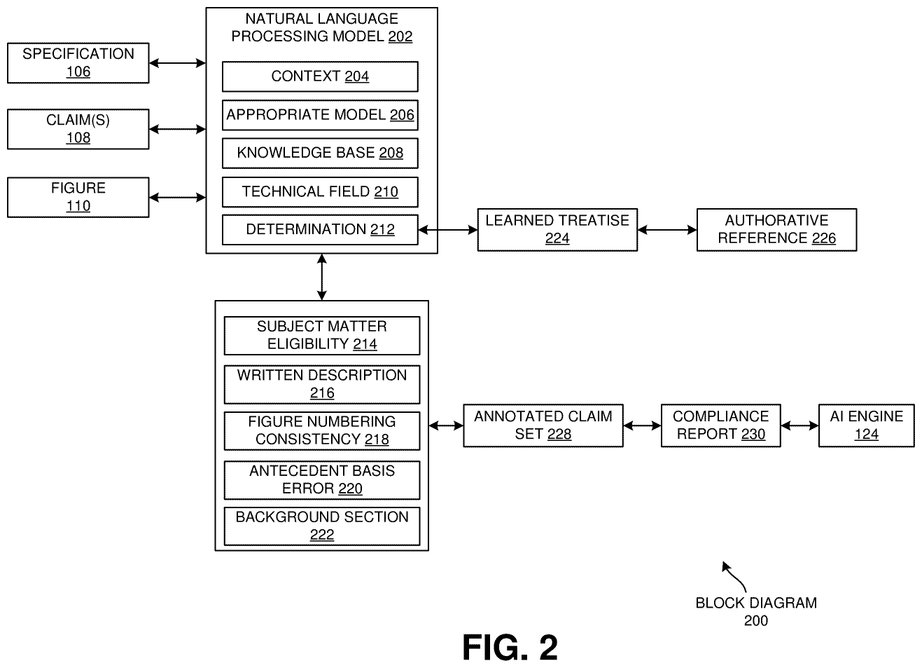

FIG. 2 is a block diagram 200 of the computer-implemented system of FIG. 1 illustrating interpretation of a claim 108, a specification 106, and one or more FIG. 110 by a natural language processing model 202, generating a determination 212, according to one embodiment. FIG. 2 illustrates the specification 106, the claim(s) 108, the FIG. 110, the artificial intelligence engine 124, a natural language processing model 202, a context 204, an appropriate model 206, a knowledge base 208, a technical field 210, a determination 212, a subject matter eligibility 214, a written description 216, a figure numbering consistency 218, an antecedent basis error 220, a background section 222, a learned treatise 224, an authoritative reference 226, an annotated claim set 228, and a compliance report 230, according to one embodiment.

The natural language processing model 202 may be a machine learning framework designed to analyze the specification 106, the claim(s) 108, and the FIG. 110 in a structured manner. The natural language processing model 202 may parse textual and graphical input into a machine-readable representation, enabling subsequent legal and technical analysis of patent submissions. The natural language processing model 202 may serve as the foundation through which other modules, including the context 204 and the determination 212, operate, according to one embodiment.

The natural language processing model 202 may process input data in parallel and/or distributed environments to achieve efficiency when handling large volumes of patent-related data. The natural language processing model 202 may integrate feedback from the annotated claim set 228 and the compliance report 230, enabling recursive improvement of parsing accuracy. The natural language processing model 202 may therefore establish a linkage between linguistic interpretation of claims and compliance evaluation under statutory provisions, according to one embodiment.

The natural language processing model 202 may direct outputs into the context 204, the appropriate model 206, the knowledge base 208, and the technical field 210, ensuring to each component receives structured information for specialized processing. The natural language processing model 202 may thus form the entry point into the artificial intelligence engine 124, preparing inputs for substantive legal and technical determinations, according to one embodiment.

The context 204 may be a module configured to assign situational meaning to terms and claim language analyzed by the natural language processing model 202. The context 204 may resolve ambiguities in a claim(s) 108 by associating technical expressions with their intended use and/or scope in the specification 106 and the FIG. 110. By doing so, the context 204 may ensure accurate interpretation aligned with the applicant's 154 disclosure, according to one embodiment.

The context 204 may dynamically interact with the knowledge base 208 to validate contextual interpretations against prior disclosures and references. The context 204 may also reference background information derived from the background section 222, thereby grounding claim interpretations in both intrinsic and extrinsic evidence. The contextualization may aid the determination 212 in providing accurate statutory evaluations, according to one embodiment.

The context 204 may further supply information to the appropriate model 206 to select the most suitable analytical framework. In coordination with the artificial intelligence engine 124, the context 204 may help establish a clear bridge between natural language inputs and structured compliance assessments, according to one embodiment, according to one embodiment.

The appropriate model 206 may be a selection mechanism to identifies the most suitable algorithmic and/or legal reasoning framework for analyzing a claim(s) 108. The appropriate model 206 may classify the claim type, including but not limited to method, apparatus, and/or composition, and align with examination rules and precedents. The appropriate model 206 may therefore enable the artificial intelligence engine 124 to apply domain-specific reasoning, according to one embodiment.

The appropriate model 206 may receive contextual cues from the context 204 and technical scope from the technical field 210, enabling refinement of its model selection. For example, if the claim(s) 108 falls within a biotechnology field, the appropriate model 206 may select specialized interpretive modules trained on life sciences precedents. The adaptability may improve compliance assessments under subject matter eligibility 214 and written description 216, according to one embodiment.

The appropriate model 206 may pass structured analysis to the determination 212, which may in turn generate compliance outcomes. Integration with the annotated claim set 228 may allow the appropriate model 206 to refine claim interpretations for downstream modules, thereby ensuring a smooth progression toward the compliance report 230, according to one embodiment. The knowledge base 208 may be a structured repository of technical and legal

information used to support analysis by the artificial intelligence engine 124. The knowledge base 208 may contain past patent examination data, statutory guidelines, authoritative interpretations, and references including the authoritative reference 226, according to one embodiment.

The knowledge base 208 may be dynamically updated through continuous ingestion of new corpus data, including patent examination outcomes, rejection rationales, and allowance trends. The updates may strengthen the ability of the determination 212 to generate accurate statutory compliance assessments. The knowledge base 208 may also interface with the learned treatise 224, allowing external academic and/or authoritative material to supplement interpretations, according to one embodiment.

The knowledge base 208 may supply substantive references to the figure numbering consistency 218, antecedent basis error 220, and background section 222 modules, which may rely on structured rules to detect errors. The knowledge base 208 may thus serve as the central reference backbone for the entire processing pipeline, according to one embodiment.

The technical field 210 may represent the domain classification of a claim(s) 108, derived from the specification 106 and the FIG. 110. The technical field 210 may ensure the claim(s) 108 may be interpreted in light of their relevant art, preventing overbroad and/or misaligned analysis, according to one embodiment.

The technical field 210 may interact with the context 204 to disambiguate terminology may differ across industries. For instance, the same phrase may have different meanings in computing and biotechnology, and the technical field 210 may enforce accurate domain-specific interpretation. The technical field 210 may thus enable the subject matter eligibility 214 module to evaluate patent-eligible concepts under statutory provisions, according to one embodiment.

The technical field 210 may provide input directly into the appropriate model 206, ensuring proper alignment between claim scope and examination logic. By linking the claims 108 with corresponding knowledge from the knowledge base 208, the technical field 210 may assist in building a comprehensive foundation for the determination 212, according to one embodiment.

The determination 212 may be a decision-making module configured to synthesize outputs from the context 204, the appropriate model 206, the knowledge base 208, and the technical field 210. The determination 212 may generate compliance outcomes regarding subject matter eligibility 214, written description 216, figure numbering consistency 218, antecedent basis error 220, and background section 222. The determination 212 may therefore serve as the critical gateway where linguistic interpretation transitions into statutory analysis, according to one embodiment.

The determination 212 may evaluate whether each limitation in a claim(s) 108 has support in the specification 106 and FIG. 110. If support may not found internally, the determination 212 may consult external sources including the learned treatise 224 and the authoritative reference 226. The determination 212 may then pass annotated outcomes into the annotated claim set 228, enabling downstream modules to reference specific tracked modifications, according to one embodiment.

The determination 212 may generate structured outputs for the compliance report 230, which may be fed into the artificial intelligence engine 124 for aggregation with other analytical modules. The determination 212 may thus anchor the flow of information between parsing layers and compliance evaluation, according to one embodiment.

The subject matter eligibility 214 may be a statutory compliance checkpoint designed to evaluate whether claims 108 fall within patent-eligible subject matter categories. The subject matter eligibility 214 may reference statutory provisions to confirm whether the claims 108 describe a process, machine, manufacture, and/or composition of matter, while excluding abstract ideas and/or natural phenomena, according to one embodiment.

The subject matter eligibility 214 may rely on contextual information derived from the technical field 210 and semantic mappings created by the natural language processing model 202. If ambiguity exists, the subject matter eligibility 214 may seek external reasoning through the learned treatise 224 and/or the authoritative reference 226. The cross-references may ensure determinations align with authoritative precedent, according to one embodiment.

The subject matter eligibility 214 may directly contribute annotated feedback into the annotated claim set 228. The annotation may then be documented in the compliance report 230, preparing the artificial intelligence engine 124 to synthesize the results into allowance, rejection, and/or amendment outcomes, according to one embodiment.

The written description 216 may be a compliance module configured to verify whether the specification 106 adequately supports each limitation of the claim(s) 108. The written description 216 may confirm the specification 106 conveys sufficient detail to demonstrate possession of the claimed invention, according to one embodiment.

The written description 216 may function in coordination with the knowledge base 208 and the context 204 to resolve whether terminology in the claim(s) 108 may be explicitly and/or inherently supported by disclosure. When ambiguity persists, the written description 216 may draw supplemental evidence from the learned treatise 224 and/or the authoritative reference 226, according to one embodiment.

The written description 216 may highlight results directly in the annotated claim set 228, where specific limitations may be flagged as adequately supported and/or lacking support. These annotations may flow into the compliance report 230 and ultimately guide determinations by the artificial intelligence engine 124, according to one embodiment.

The figure numbering consistency 218 may be a verification module designed to evaluate alignment between the FIG. 108 and the textual references within the specification 106. The figure numbering consistency 218 may detect inconsistencies including but not limited to missing references, duplicate numbering, and/or misaligned figure callouts, according to one embodiment.

The figure numbering consistency 218 may use the natural language processing model 202 to parse figure references within the specification 106, cross-mapping them against metadata tags embedded within the FIG. 108. The figure numbering consistency 218 may further generate alerts when an inconsistency may create a statutory compliance defect under 35 U.S.C. § 112, according to one embodiment.

The figure numbering consistency 218 may transmit findings into the annotated claim set 228 and subsequently into the compliance report 230. The figure numbering consistency 218 may then direct unresolved issues toward amendment generation 402 and/or suggested acceptance 404, depending on whether corrections may be automated and/or may require applicant 156 intervention, according to one embodiment.

The antecedent basis errors 220 may be a compliance check designed to detect claim drafting defects under 35 U.S.C. § 112(b). The antecedent basis errors 220 may identify claim terms lack proper introduction and/or reference, leading to indefiniteness, according to one embodiment.

The antecedent basis errors 220 may be analyzed by the artificial intelligence engine 124 using the natural language processing model 202 to parse claim terms and identify initial versus subsequent appearances. The context 204, the appropriate model 206, and the knowledge base 208 may support resolution of claim structure by cross-referencing claim elements with specification 106 disclosure and FIG. 110. The technical field 210 may provide domain-specific expectations for terminology consistency, according to one embodiment.

The antecedent basis errors 220 may be annotated within the annotated claim set 228 and summarized in the compliance report 230. The artificial intelligence engine 124 may propose examiner's amendment options within claim amendment 402 to correct detected antecedent basis errors. The antecedent basis errors 220 may then lead into the background section 222, according to one embodiment.

The background section 222 may be a portion of the specification 106 containing contextual disclosure about the field of the invention and related work. The background section 222 may provide narrative context but may also contain language construed as admissions of prior art, potentially limiting scope of the claim(s) 108, according to one embodiment.

The background section 222 may be parsed by the natural language processing model 202 to isolate statements resemble admissions against interest. The artificial intelligence engine 124 may compare extracted statements with authoritative reference 226 and learned treatise 224 to classify whether a statement constitutes harmless context and/or a substantive admission. The knowledge base 208 and the technical field 210 may guide interpretation of domain-specific terminology to determine whether the background section 222 undermines novelty and/or non-obviousness, according to one embodiment.

The background section 222 may output annotations into the annotated claim set 228 and findings into the compliance report 230. When problematic statements may be detected, the artificial intelligence engine 124 may recommend amendment 402 and/or suggested acceptance 404 with supporting citations 150. The background section 222 may complete the compliance evaluation sequence and direct results into the prior art search module 128 for further novelty and obviousness analysis, according to one embodiment.

The learned treatise 224 may be an external knowledge source used to supplement analysis of the claim(s) 108 when the specification 106 does not provide intrinsic support. The learned treatise 224 may comprise scholarly writings, technical manuals, scientific journals, and/or domain-specific publications recognized as reliable within the technical field 210. The learned treatise 224 may serve as an evidentiary authority traditionally cited under patent examination standards to clarify accepted principles of science and engineering, according to one embodiment.

The learned treatise 224 may be accessed by the artificial intelligence engine 124 through the natural language processing model 202. The learned treatise 224 may provide additional definitional clarity for claim terms and may validate whether a limitation has recognized meaning in the art. The context 204 and the appropriate model 206 may assist the artificial intelligence engine 124 in selecting the most relevant excerpts from the learned treatise 224, ensuring alignment with the subject matter of the claim(s) 108 and the disclosure of the specification 106, according to one embodiment.

The learned treatise 224 may transmit validated explanations into the annotated claim set 228 and the compliance report 230. When the written description 216 and/or background section 222 indicates insufficient support (or definition of a claim element needs further clarification), the learned treatise 224 may contribute authoritative justification. The learned treatise 224 may operate in conjunction with the authoritative reference 226 to reinforce statutory compliance determinations, according to one embodiment, according to one embodiment.

The authoritative reference 226 may be a recognized source of binding and/or persuasive authority applied during statutory compliance review. The authoritative reference 226 may include but not be limited to judicial decisions, examiner guidelines, statutory definitions, and/or government-issued technical standards. The authoritative reference 226 may ensure to interpretations of claim(s) 108 and specification 106 remain consistent with precedent and established examination practice, according to one embodiment.

The authoritative reference 226 may be applied by the artificial intelligence engine 124 during interpretation of claim language and background section 222. The natural language processing model 202 may compare claim limitations and specification passages against the authoritative reference 226 to confirm adherence to patent law requirements. The context 204, the appropriate model 206, and the knowledge base 208 may further align interpretations with doctrinal principles established in the authoritative reference 226, according to one embodiment.

The authoritative reference 226 may contribute citations 150 directly into the annotated claim set 228 and the compliance report 230. When an inconsistency and/or deficiency may be detected, the authoritative reference 226 may validate an amendment 402 and/or a suggested acceptance 404. The authoritative reference 226 may complement the learned treatise 224 to provide comprehensive external support for the artificial intelligence engine 124 in generating determinations of subject matter eligibility 214, written description 216, antecedent basis errors 220, and background section 222, according to one embodiment.

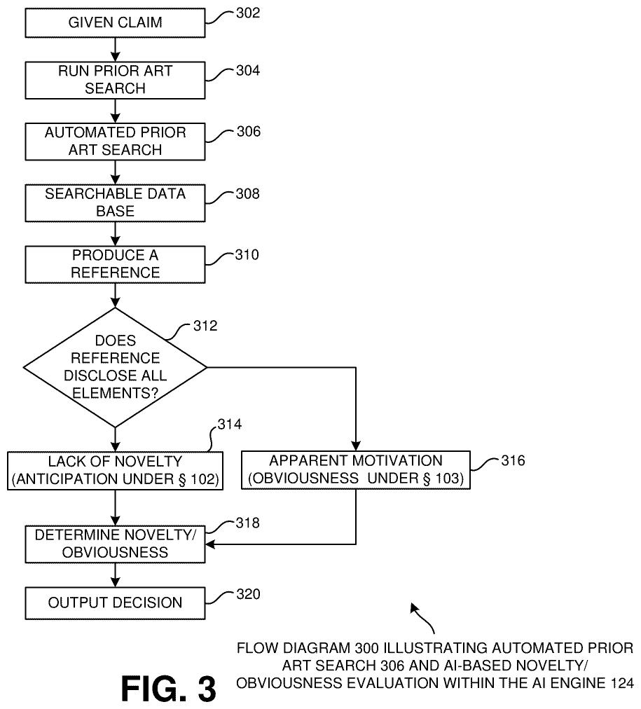

FIG. 3 is a flow diagram 300 illustrating automated prior art search 306 and AI-based novelty/obviousness evaluation within an AI engine 124 of a computer-implemented system of FIG. 1, according to one embodiment. FIG. 3 illustrates a given claim 302, a run prior art search 304, an automated prior art search 306, a searchable database 308, a produce a reference 310, a decision block 312, a lack of novelty 314, an apparent motivation 316, a determine novelty/obviousness 318, and an output decision 320, according to one embodiment.

The given claim 302 may represent an individual claim selected from the claim(s) 108 of the utility patent application 104. The given claim 302 may include limitations drafted to define the scope of the invention disclosed in the specification 106 and depicted in the FIG. 110, according to one embodiment.

The given claim 302 may be parsed by the natural language processing model 202 to identify individual limitations. The parsing may map each limitation to supporting passages in the specification 106 and FIG. 110 while referencing external sources including the learned treatise 224 and the authoritative reference 226, according to one embodiment.

The given claim 302 may initiate the sequence of the flow diagram 300 by transmitting claim limitations into the run prior art search 304 for evaluation of novelty under § 102 and obviousness under § 103, according to one embodiment.

The run prior art search 304 may be an initiation step configures the artificial intelligence engine 124 to query one or more searchable databases 308. The run prior art search 304 may prepare semantic search queries, keyword-based queries, and concept-driven queries. The run prior art search 304 may leverage the context 204, the appropriate model 206, and the knowledge base 208 to identify domain-specific terminology. The run prior art search 304 may further structure queries to target patent and non-patent literature repositories within the searchable databases 308, according to one embodiment.

The run prior art search 304 may activate the automated prior art search 306 by transmitting queries and extracting feature sets derived from the given claim 302, according to one embodiment.

The automated prior art search 306 may perform a fully computer-implemented search operation across the searchable databases 308. The automated prior art search 306 may execute queries in parallel using the parallel/distributed computing context 604 to reduce evaluation time. The automated prior art search 306 may retrieve candidate references, analyze claim term coverage, and align text fragments with claim limitations. The automated prior art search 306 may apply machine learning models trained on the corpus of patent examination data 136 to prioritize references with high relevance, according to one embodiment.

The automated prior art search 306 may transmit retrieved references into the searchable database 308 for subsequent processing by the produce a reference 310, according to one embodiment.

The searchable database 308 may be a collection of electronic repositories containing patent literature, non-patent scientific publications, and technical disclosures. The searchable database 308 may support indexed search, semantic retrieval, and metadata-driven filtering. The searchable database 308 may be continuously updated to incorporate newly published applications, issued patents, and technical standards. The searchable database 308 may interoperate with the corpus of patent examination data 136 to calibrate weighting factors for relevance scoring, according to one embodiment.

The searchable database 308 may provide the automated prior art search 306 with references for analysis and may further output the references into the produce a reference 310 for formal evaluation, according to one embodiment.

The produce a reference 310 may generate a structured output identifying each retrieved prior art document. The produce a reference 310 may list bibliographic details, excerpts, and mapped claim elements, according to one embodiment.

The produce a reference 310 may prepare comparison tables aligning limitations from the given claim 302 against disclosures in the references. Each reference may be marked with confidence levels generated through machine learning models of the artificial intelligence engine 124. The produce a reference 310 may transmit the structured reference data into the decision block 312 for assessment of novelty and obviousness, according to one embodiment.

The decision block 312 may evaluate whether the produced reference 310 discloses all elements of the given claim 302. The decision block 312 may compare each claim limitation against corresponding disclosures identified by the automated prior art search 306, according to one embodiment.

The decision block 312 may apply examiner guidelines derived from the authoritative reference 226 and may use comparative rules stored in the knowledge base 208. When all limitations of the given claim 302 appear in a single reference, the decision block 312 may transmit the determination into the lack of novelty 314. When elements require multiple references, the decision block 312 may transmit the determination into the apparent motivation 316, according to one embodiment.

The decision block 312 may prepare the foundation for novelty and obviousness determinations, which may be formally completed within the determine novelty/obviousness 318, according to one embodiment.

The lack of novelty 314 may represent a determination under 35 U.S.C. § 102 that disclosure in a single prior art reference describes every limitation of the given claim 302. The lack of novelty 314 may rely on mappings from the produce a reference 310. The lack of novelty 314 may generate outputs highlighting specific disclosures in the reference, cross-referenced against claim limitations. The lack of novelty 314 may also mark claim language requiring narrowing amendments 402, according to one embodiment.

The lack of novelty 314 may transmit results into the determine novelty/obviousness 318, where integration with other determinations occurs, according to one embodiment.

The apparent motivation 316 may represent a determination under 35 U.S.C. § 103 two or more references collectively disclose all claim limitations. The apparent motivation 316 may rely on the decision block 312 to identify references requiring combination, according to one embodiment.

The apparent motivation 316 may evaluate whether a person of ordinary skill in the art would have been motivated to combine the references. The evaluation may incorporate reasoning principles contained within the corpus of patent examination data 136 and the legal reasoning engine 602. The apparent motivation 316 may transmit reasoning statements into the determine novelty/obviousness 318, where novelty and obviousness may be consolidated for the final analysis, according to one embodiment.

The determine novelty/obviousness 318 may aggregate results from the lack of novelty 314 and the apparent motivation 316. The determine novelty/obviousness 318 may prepare a unified assessment consistent with examiner practice, according to one embodiment.

The determine novelty/obviousness 318 may cross-reference statutory compliance checks including written description 216, antecedent basis errors 220, and background section 222 to ensure alignment between claim scope and specification 106. The determine novelty/obviousness 318 may integrate reasoning from the legal reasoning engine 602 for consistency with examiner outcomes, according to one embodiment.

The determine novelty/obviousness 318 may transmit the consolidated assessment into the output decision 320 for generation of allowance, rejection, and/or amendment proposals, according to one embodiment.

The output decision 320 may represent the final determination generated by the artificial intelligence engine 124. The output decision 320 may include a notice of allowance 140, a written rejection 142, and/or a proposed amendment 144, according to one embodiment.

The output decision 320 may incorporate citations 150 to prior art references, annotated claim sets 228 showing tracked changes, and quantified confidence scores 152 representing the probability of allowance 154. The output decision 320 may also prepare applicant-facing outputs delivered through the user interface view 700, according to one embodiment.

The output decision 320 may transmit results to the applicant 156, enabling near-instant determination of allowance, rejection, and/or conditional allowance with amendment, according to one embodiment.

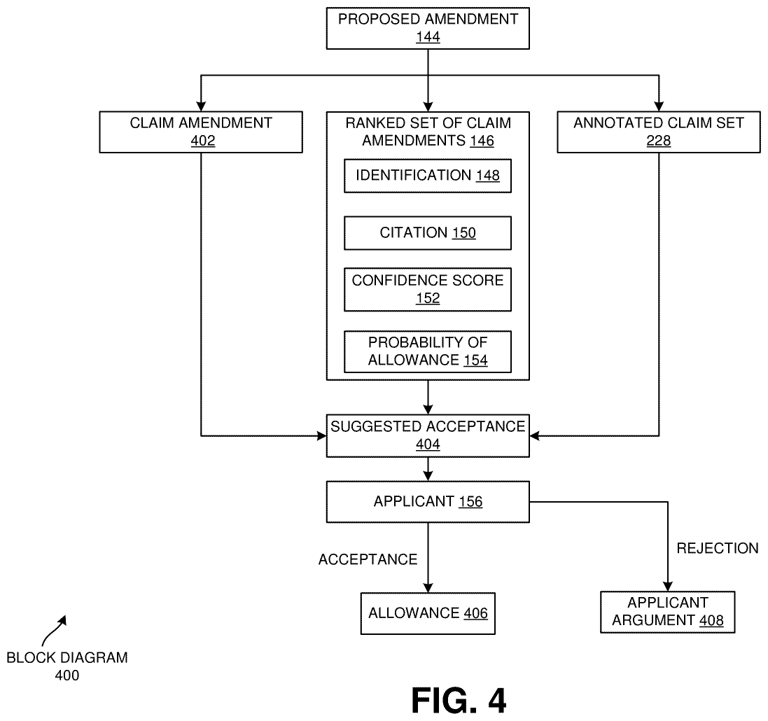

FIG. 4 is a block diagram 400 of the computer-implemented system of FIG. 1 illustrating amendment generation and the applicant 156 interaction, including creation of proposed amendments 142, annotated claim sets 228, and ranked set of claim amendments 144 for applicant 156, acceptance and/or rejection, according to one embodiment. FIG. 4 illustrates the proposed amendment 144, the ranked set of claim amendments 146, the identification 148, the citation 150, the confidence score 152, the probability of allowance 154, the applicant 156, the annotated claim set 228, a claim amendment 402, a suggested acceptance 404, allowance 406, and applicant argument 408, according to one embodiment.

The claim amendment 402 may be a structured modification to claim(s) 108 generated by the artificial intelligence engine 124 to align the pending claims with statutory patentability requirements. The claim amendment 402 may include language adjustments, insertion of additional limitations, and/or removal of overly broad terms, all derived from intrinsic evidence within the specification 106 and FIG. 110. The claim amendment 402 may be produced when the artificial intelligence engine 124 determines, through analysis steps including subject matter eligibility 214, written description 216, antecedent basis errors 220, and background section 222, to the original claim set requires revisions to overcome prior art and/or statutory deficiencies, according to one embodiment.

The claim amendment 402 may be the corrective layer between the proposed amendment 144 and the annotated claim set 228. The claim amendment 402 may ensure each independent claim, and when necessary each dependent claim, contains adequate support from the specification 106 and figure numbering consistency 218. The claim amendment 402 may also integrate evidence retrieved from citations 150 reference supporting disclosure and/or distinguish closest prior art 504. In addition, the claim amendment 402 may incorporate refinements designed to avoid lack of novelty under § 102 and/or reduce apparent motivation to combine prior art under § 103, as outlined within determinations in flow diagram 300, according to one embodiment.

The claim amendment 402 may be presented to applicant 156 within a user interface view 800, displayed in tracked-change format through the annotated claim set 228. The claim amendment 402 may include strikethroughs for deleted phrases and underlines for added text, providing a transparent redline view. The claim amendment 402 may also be ranked within the ranked set of alternative claim amendments 144, supported by quantified confidence score 150 and probability of allowance 154, giving applicant 156 predictive insight into the amendment's effectiveness. When applicant 156 accepts the claim amendment 402, the suggested acceptance 404 may transition the case toward allowance 406, while applicant arguments 408 may alternatively be invoked to dispute and/or refine the modification, according to one embodiment.

The suggested acceptance 404 may be a recommendation generated by the artificial intelligence engine 124 to guide applicant 156 toward adopting a claim amendment 402. The suggested acceptance 404 may present a simplified directive, framed in plain English, to encourages applicant 156 to accept modifications derived from the annotated claim set 228. The suggested acceptance 404 may reduce uncertainty for applicant 156 by clarifying the amendment aligns with statutory compliance requirements including subject matter eligibility 214, written description 216, figure numbering consistency 218, antecedent basis errors 220, and background section 222, according to one embodiment.

The suggested acceptance 404 may serve as the transitional decision point between a proposed amendment 144 and the issuance of allowance 406. The suggested acceptance 404 may summarize the rationale behind the amendment by referencing authoritative reference 226, learned treatise 224, and citations 150 to specification 106 and/or FIG. 110. The suggested acceptance 404 may therefore communicate why the amendment eliminates prior art overlap, reduces risk of rejection under § 102 and/or § 103, and increases the probability of allowance 154, according to one embodiment.

The suggested acceptance 404 may direct applicant 156 to either confirm the amendment and proceed toward allowance 406, and/or to invoke applicant arguments 408 if disagreement remains. The suggested acceptance 404 may be displayed through user interface view 800 with options including accept amendments, request alternative amendments, and/or review explanation. The integration may create transparency for applicant 156 while maintaining consistency with ranked set of alternative claim amendments 144 and quantified confidence score 150, according to one embodiment.

The allowance 406 may be a system-generated confirmation the utility patent application meets all statutory requirements and may be in condition for issuance as a granted patent. The allowance 406 may be triggered when applicant 156 accepts a suggested acceptance 404 and/or directly adopts a claim amendment 402 without dispute. The allowance 406 may rely upon determinations from the natural language processing model 202, context 204, appropriate model 206, and knowledge base 208, in combination with results from prior art search and determination of novelty and obviousness, according to one embodiment.

The allowance 406 may reflect the final outcome of automated evaluation by the artificial intelligence engine 124, signifying compliance with patentability standards under 35 U.S.C. § 101, § 102, and § 103, as well as disclosure sufficiency under § 112. The allowance 406 may be supported by explanatory content within compliance report 230, which may include cross-references to supporting paragraphs in specification 106, validated FIG. 110, and citations 150 confirming alignment with authoritative reference 226 and/or learned treatise 224, according to one embodiment.

The allowance 406 may be delivered to applicant 156 through output decision 138 in the form of the notice of allowance 140. The allowance 406 may also integrate into downstream reporting where quantified confidence score 150 and probability of allowance 154 may be logged as part of continuous improvement in retraining process 606 of the legal reasoning engine 602. The allowance 406 may therefore establish the final positive resolution pathway for the electronic submission 102, according to one embodiment.

The applicant arguments 408 may be a structured response pathway enabling applicant 156 to contest and/or refine the claim amendment 402 rather than adopting suggested acceptance 404. The applicant arguments 408 may include legal and/or technical rebuttals drafted by applicant 156 and/or by counsel, uploaded into the system through user interface view 800, and evaluated again by the artificial intelligence engine 124. The applicant arguments 408 may be framed against identified prior art references produced under automated prior art search 306, citations 150, and issues raised in compliance report 230, according to one embodiment.

The applicant arguments 408 may function as a counterpart to proposed amendment 144, allowing applicant 156 to maintain original claim scope when strategic and/or commercial considerations outweigh the benefit of narrowing amendments. The applicant arguments 408 may challenge examiner-style findings generated by the system by disputing lack of novelty 314, contesting apparent motivation 316, and/or clarifying written description 216 and enablement sufficiency, according to one embodiment.

The applicant arguments 408 may lead the artificial intelligence engine 124 to produce a revised output decision 138 either reaffirms a written rejection 142, proposes a new amendment 402, and/or escalates the application toward manual review. The applicant arguments 408 may therefore create a feedback loop integrates into feedback from confirmed allowances and rejections 610, strengthening retraining process 606 of a legal reasoning engine 602. The applicant arguments 408 may provide the applicant 156 with agency while keeping the system consistent with statutory frameworks, according to one embodiment, according to one embodiment.

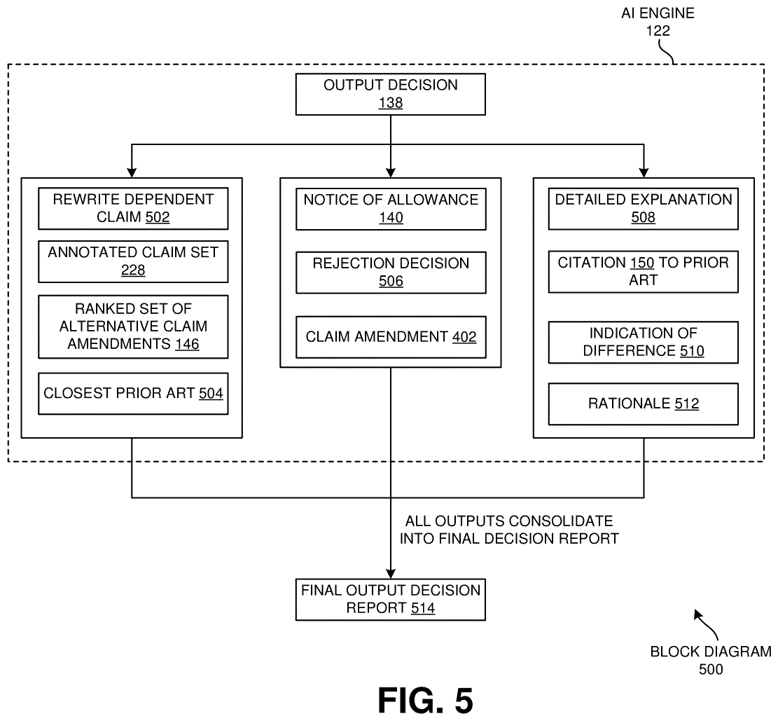

FIG. 5 is a block diagram 500 of the computer-implemented system of FIG. 1 illustrating output decision 138, with branching results including a notice of allowance 140, and a rejection decision 506, according to one embodiment. FIG. 5 illustrates the artificial intelligence engine 124, the output decision 138, the notice of allowance 140, the ranked set of alternative claim amendments 146, the citation 150, the annotated claim set 228, a rewrite dependent claim 502, a closest prior art 504, a rejection decision 506, a detailed explanation 508, an indication of difference 510, a rationale 512, and a final output decision report 514, according to one embodiment.

The rewrite dependent claim 502 may be a decision-making step where the artificial intelligence engine 124 automatically identifies dependent claims containing non-obvious limitations. The rewrite dependent claim 504 may elevate a dependent claim into an independent form to overcome rejection grounds, including but not limited to grounds under § 102 and/or § 103. The automated process may preserve applicant rights by salvaging allowable matter from rejected independent claims, according to one embodiment.

The rewrite dependent claim 504 may compare claim limitations with the closest prior art 504 to identify distinctions establishing novelty and non-obviousness. The rewrite dependent claim 504 may analyze the annotated claim set 228 and cross-reference supporting passages in the specification 106. The process may then restructure a claim hierarchy without altering support in the specification 106 and/or the FIG. 108. The rewrite dependent claim 504 may ensure amendments proposed to the applicant 156 retain statutory support while overcoming novelty and/or obviousness rejections, according to one embodiment.

The rewrite dependent claim 504 may forward results into the annotated claim set 228 for visual representation. The output may flow into the ranked set of alternative claim amendments 144 for presentation to the applicant 156. The results may form part of the final output decision report 514 for the applicant 156 to review., according to one embodiment.

The closest prior art 504 may be a reference identified during automated prior art search 306 and novelty/obviousness determination 318. The closest prior art 504 may represent a patent and/or non-patent literature reference most relevant to claim(s) 108, providing a benchmark for both rejection decision 506 and proposed amendment 402, according to one embodiment.

The closest prior art 504 may be annotated with indication of difference 510, highlighting limitations present in claim(s) 108 but absent from the reference. The closest prior art 504 may guide the artificial intelligence engine 124 in selecting dependent claims for rewriting under 502 and/or in generating annotated claim set 228 and ranked set of alternative claim amendments 144, according to one embodiment.

The rejection decision 506 may be an output decision generated within output decision 138 through processing by artificial intelligence engine 124. The rejection decision 506 may indicate claim(s) 108 fail to meet statutory requirements for novelty under § 102 and/or non-obviousness under § 103. The rejection decision 506 may incorporate closest prior art 504 as a reference baseline, citation 150 linking claim language to specific disclosures, and rationale 512 providing examiner-style reasoning consistent with Manual of Patent Examining Procedure (MPEP) guidelines. The rejection decision 506 may therefore replicate the structured legal format of an office action, presenting a comprehensive explanation of statutory deficiencies, according to one embodiment.

The rejection decision 506 may be accompanied by amendment pathways designed to guide applicant 156 toward allowance. The pathways may include claim amendment 402 for targeted narrowing, rewrite dependent claim 502 to elevate allowable limitations into independent form, and ranked set of alternative claim amendments 144 to reflect statistically prioritized strategies. The rejection decision 506 may further enable applicant 156 to prepare arguments by providing detailed explanation 508 with integrated citation 150 and indication of difference 510. Through the resources, the rejection decision 506 may establish both an authoritative denial and a constructive roadmap toward allowance, according to one embodiment.

The detailed explanation 508 may be a narrative generated by artificial intelligence engine 124 to articulate examiner-style reasoning supporting allowance, rejection, and/or amendment of claim(s) 108. The detailed explanation 508 may translate analytical outputs into a structured textual report resembling an office action, thereby bridging computational determinations with legally recognized formats. The detailed explanation 508 may describe how claim interpretation performed by natural language processing model 202, context 204, and knowledge base 208 interacts with novelty analysis under § 102 and obviousness analysis under § 103, according to one embodiment.

The detailed explanation 508 may apply examiner guidelines drawn from the Manual of Patent Examining Procedure, including recognized rationales for combining references when assessing claim scope against closest prior art 504. The detailed explanation 508 may clarify how claim amendment 402, rewrite dependent claim 502, and/or ranked set of alternative claim amendments 144 strategically address deficiencies by narrowing claim breadth while retaining statutory compliance, according to one embodiment.

The detailed explanation 508 may further integrate authoritative reference 226 and learned treatise 224 to support doctrinal accuracy. References may be cited alongside claim language, creating a transparent record for applicant 156. The detailed explanation 508 may therefore function as both a justification of output decision 138 and an educational resource guiding applicant 156 toward allowance, according to one embodiment.

The indication of difference 510 may be an output generated by artificial intelligence engine 124 to highlight claim limitations from claim(s) 108 not disclosed in closest prior art 504. The indication of difference 510 may create a clear mapping between each claim element and the prior art reference, identifying specific features absent from the prior disclosure. The indication of difference 510 may therefore provide applicant 156 with a direct and accessible explanation of how novelty under § 102 and/or non-obviousness under § 103 may be established, according to one embodiment.

The indication of difference 510 may be displayed in plain English, simplifying legal and technical distinctions for applicant 156. Plain-language phrasing may help clarify why limitations including structural features, process steps, and/or functional elements of claim(s) 108 remain outside the scope of closest prior art 504. The presentation may improve transparency and reduce reliance on attorney-specific interpretation, thereby empowering applicant 156 to understand patentability challenges directly, according to one embodiment.

The indication of difference 510 may further support rewrite dependent claim 502 and ranked set of alternative claim amendments 144 by pinpointing allowable distinctions. The indication of difference 510 may also inform rationale 512 by providing precise factual bases for allowance and/or rejection, strengthening both detailed explanation 508 and final output decision 518, according to one embodiment.

The rationale 512 may be a reasoning component generated by artificial intelligence engine 124 to articulate statutory grounds for allowance, rejection, and/or amendment of claim(s) 108. The rationale 512 may provide examiner-style logic to evaluates whether closest prior art 504 discloses all elements of claim(s) 108 under § 102 and/or whether a motivation to combine multiple references exists under § 103. The rationale 512 may therefore represent the core analytical framework aligning output decision 138 with established patent law principles, according to one embodiment.

The rationale 512 may accompany rejection decision 506, notice of allowance 140, and/or proposed claim amendment 402 to ensure to the applicant 156 receives transparent justification for each outcome. The rationale 512 may rely on authoritative reference 226 and learned treatise 224 for doctrinal validation, and may draw upon annotated claim set 228 and citations 150 to show clear correspondence between identified references and claim elements. The structured reasoning may reinforce compliance with examiner standards while improving applicant comprehension, according to one embodiment.

The rationale 512 may also serve as the foundation for detailed explanation 508 by supplying logical steps and statutory citations. The rationale 512 may directly feed into final output decision report 514, forming the structured argument substantiates allowance, rejection, and/or amendment recommendations, according to one embodiment.

The final output decision report 514 may be a consolidated record generated by artificial intelligence engine 124 compiles every determination produced during automated examination of claim(s) 108. The final output decision report 514 may integrate notice of allowance 140, rejection decision 506, proposed claim amendment 402, annotated claim set 228, citations 150, rationale 512, indication of differences 510, and quantified confidence score 152 into a single comprehensive package. The final output decision report 514 may therefore provide applicant 156 with a unified view of statutory compliance analysis, prior art comparison, and amendment opportunities in a near-instant format, according to one embodiment.

The final output decision report 514 may be automatically prepared in both machine-readable and human-readable formats. The machine-readable format may enable downstream processing, archiving, and/or integration with prosecution management systems, while the human-readable format may present plain-English explanations alongside tracked changes in claim amendment 402 and annotations in annotated claim set 228. The final output decision report 514 may allow applicant 156 to accept amendments, submit arguments addressing rejection decision 506, and/or proceed directly to allowance confirmed by notice of allowance 140, according to one embodiment.

The final output decision report 514 may complete the examination workflow of block diagram 500 by closing the evaluation cycle, transmitting all determinations to applicant 156, and enabling agreement-based progression toward allowance and/or continued prosecution, according to one embodiment.

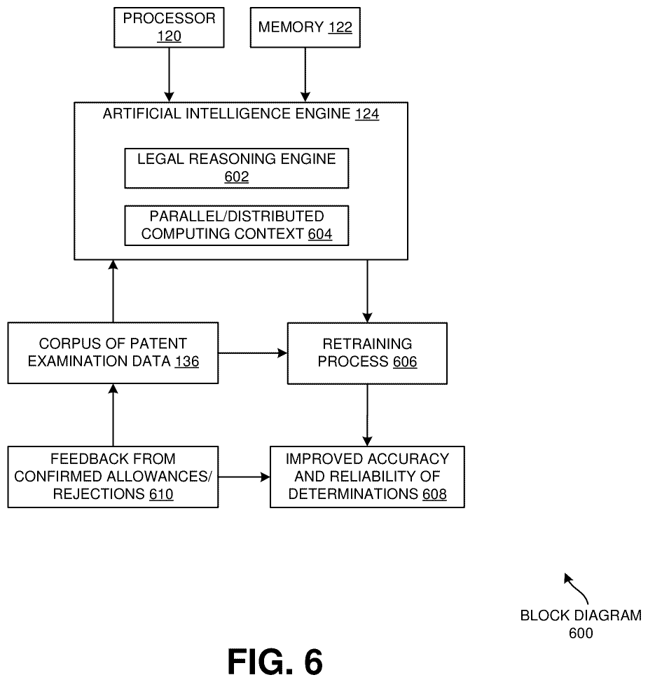

FIG. 6 is a block diagram 600 of the computer-implemented system of FIG. 1 illustrating a legal reasoning engine 602 trained on a corpus of patent examination data 136 with feedback loops and periodic retraining to improve allowance and rejection determination, according to one embodiment. FIG. 6 illustrates the processor 120, the memory 122, the artificial intelligence engine 124, the corpus of patent examination data 136, a legal reasoning engine 602, a parallel/distributed computing context 604, a retraining process 606, an improved accuracy and reliability of determinations 608, and a feedback from confirmed allowances/rejections 610, according to one embodiment.

The legal reasoning engine 602 may be a decision-making sub-component embedded within artificial intelligence engine 124 designed to replicate examiner-style reasoning applied during patent examination. The legal reasoning engine 602 may operationalize statutory standards under 35 U.S.C. § 101 to confirm the claim(s) 108 pertain to statutory subject matter categories including but not limited to processes, machines, manufactures, and compositions of matter. The legal reasoning engine 602 may additionally evaluate compliance under 35 U.S.C. § 102 by determining whether a single prior art reference disclosed through closest prior art 504 anticipates certain claim limitations. For non-obviousness review, the legal reasoning engine 602 may apply 35 U.S.C. § 103, analyzing whether combinations of multiple references retrieved during automated prior art search 306 provide an apparent motivation to combine. Written description requirements under 35 U.S.C. § 112 may also be applied by the legal reasoning engine 602 to evaluate sufficiency of specification 106 in supporting claim scope, according to one embodiment.

The legal reasoning engine 602 may further generate structured rationale 512, indication of difference 510, and detailed explanation 508. The legal reasoning engine 602 may consult corpus of patent examination data 136 and feedback from confirmed allowances/rejections 610 to align its determinations with examiner-confirmed precedent. Outputs from the legal reasoning engine 602 may directly inform claim amendment 402, annotated claim set 228, and final output decision report 514, thereby enabling applicant 156 to receive near-instant determinations to remain consistent with both statutory law and procedural practice, according to one embodiment.

The parallel/distributed computing context 604 may be an execution framework embedded within artificial intelligence engine 124 configured to divide analytical workloads into concurrent sub-processes. The parallel/distributed computing context 604 may allocate distinct computational threads to operations including but not limited to claim parsing, automated prior art search 306, statutory compliance evaluation of subject matter eligibility 214, written description 216, figure numbering consistency 218, and antecedent basis error 220 detection. By distributing tasks across multiple processor 120 cores and/or interconnected servers, the parallel/distributed computing context 604 may reduce overall processing time and enable near-instant evaluation of utility patent application submissions, according to one embodiment.

The parallel/distributed computing context 604 may additionally manage concurrent access to corpus of patent examination data 136, searchable database 308, and authoritative reference 226. Synchronization protocols within the parallel/distributed computing context 604 may ensure query results, citations 150, and closest prior art 504 align across simultaneously executed tasks. Outputs from the parallel/distributed computing context 604 may feed into legal reasoning engine 602, enabling generation of rationale 512, indication of difference 510, and detailed explanation 508 without sequential bottlenecks, according to one embodiment.

The parallel/distributed computing context 604 may also support retraining process 606 by enabling distributed ingestion of feedback from confirmed allowances/rejections 610, thereby improving accuracy and reliability of determinations 608. Through integration of load balancing and distributed memory allocation, the parallel/distributed computing context 604 may maintain efficiency when scaling across diverse utility patent application types, providing consistent execution of output decision 138 within artificial intelligence engine 124, according to one embodiment.

The retraining process 606 may be a dynamic updating mechanism within artificial intelligence engine 124 configured to incorporate new data into existing analytical models. The retraining process 606 may continuously adapt the performance of legal reasoning engine 602 and parallel/distributed computing context 604 by processing corpus of patent examination data 136 along with feedback from confirmed allowances/rejections 610. Through iterative adjustments, the retraining process 606 may refine pattern recognition and reasoning pathways to support determination of novelty under § 102 and non-obviousness under § 103, as well as written description sufficiency under § 112, according to one embodiment.

The retraining process 606 may further integrate results from rejected and allowed claim(s) 108 into machine learning layers, creating a continuously expanding decision framework. Historical annotations within annotated claim set 228, citations 150, and closest prior art 504 may serve as labeled examples during retraining cycles. By adjusting weight assignments across decision nodes, the retraining process 606 may reduce misclassifications and improve predictive alignment with examiner standards, according to one embodiment.

The retraining process 606 may also support cross-validation across distributed servers in parallel/distributed computing context 604. Each cycle of the retraining process 606 may generate enhanced models to strengthen rationale 512, detailed explanation 508, and indication of difference 510. Over time, the retraining process 606 may yield improved accuracy and reliability 608 of determinations, ensuring the artificial intelligence engine 124 maintains conformity with evolving legal standards and examiner practices, according to one embodiment.

The improved accuracy and reliability of determinations 608 may represent the measurable enhancement of outcomes generated by artificial intelligence engine 124 following continuous operation of retraining process 606 and integration of legal reasoning engine 602. The improved accuracy and reliability of determinations 608 may reflect consistency in allowance, rejection decision 506, claim amendment 402, rationale 512, and final output decision report 514 with standards applied by a human examiner. By leveraging corpus of patent examination data 136 and feedback from confirmed allowances/rejections 610, the improved accuracy and reliability of determinations 608 may establish predictable, legally defensible results, according to one embodiment.

The improved accuracy and reliability of determinations 608 may further support confidence scores 150 and probabilities of allowance 154 assigned to each proposed amendment 402 and/or ranked set of alternative claim amendments 144. Over time, integration of closest prior art 504, indication of difference 510, and detailed explanation 508 may provide transparent traceability to each determination, strengthening applicant 156 confidence in system recommendations, according to one embodiment.

The improved accuracy and reliability of determinations 608 may ensure the output decision 138 aligns with statutory requirements of §§ 101, 102, 103, and 112, reducing variability across cases. Through parallel/distributed computing context 604, the improved accuracy and reliability of determinations 608 may propagate across system instances, ensuring uniform performance. The improved accuracy and reliability of determinations 608 may therefore complete the feedback loop of block diagram 600, securing consistency with evolving examiner practice, according to one embodiment.

The feedback from confirmed allowances/rejections 610 may represent validated outcomes received after issuance of notice of allowance 140 and/or written rejection 142 by a human examiner and/or through subsequent appeal results. The feedback from confirmed allowances/rejections 610 may serve as authoritative guidance for calibrating artificial intelligence engine 124 by distinguishing between accurate determinations and erroneous outputs. The feedback from confirmed allowances/rejections 610 may integrate into retraining process 606, ensuring continuous alignment with statutory provisions under §§ 101, 102, 103, and 112, according to one embodiment.

The feedback from confirmed allowances/rejections 610 may further reinforce legal reasoning engine 602 by refining rationale 512 and indication of difference 510, enhancing transparency and adherence to examiner-style reasoning. The feedback from confirmed allowances/rejections 610 may also strengthen the contextual link between closest prior art 504, claim amendment 402, and detailed explanation 508, ensuring the amendment, acceptances, and rejections proposed by the system remain consistent with real-world practice, according to one embodiment.

The feedback from confirmed allowances/rejections 610 may additionally enhance reliability of quantified confidence score 152 and probability of allowance 154 associated with ranked set of alternative claim amendments 144. By providing structured, iterative validation, the feedback from confirmed allowances/rejections 610 may directly drive improved accuracy and reliability of determinations 608, completing the adaptive feedback loop of block diagram 600, according to one embodiment.

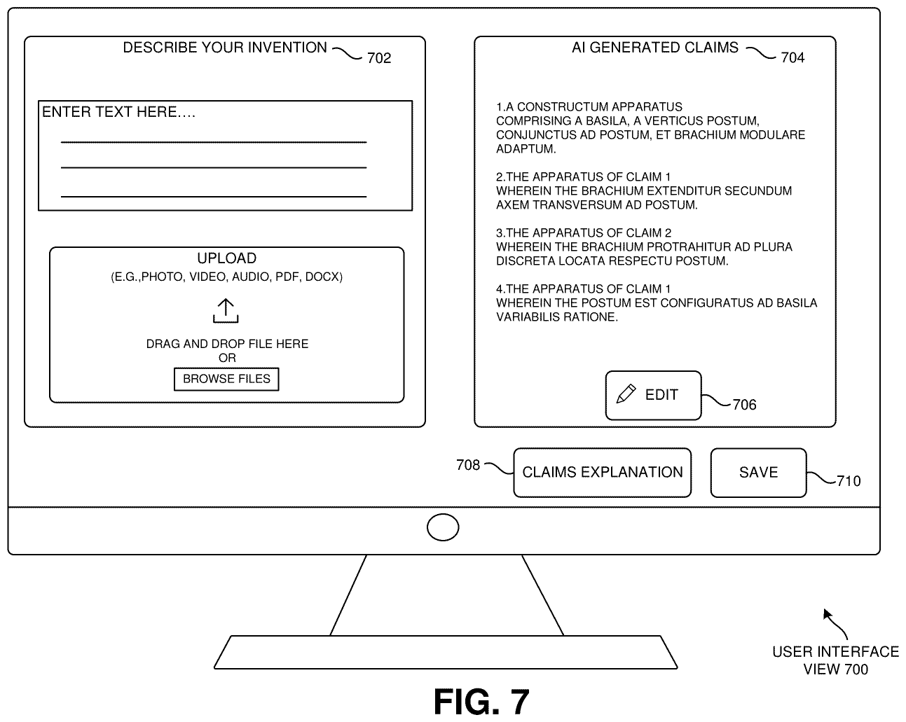

FIG. 7 is a user interface view 700 illustrating auto-generation of draft claims of a utility patent application 104 using an AI engine 124 of the computer-implemented system of FIG. 1, according to one embodiment. FIG. 7 illustrates a describe your invention panel 702, an AI generated claims panel 704, an edit 706 button, a claims explanation 708 button, and a save 710 button, according to one embodiment.

The describe your invention panel 702 may be a graphical input environment configured to capture disclosure information provided by applicant 156. The describe your invention panel 702 may incorporate a structured text entry field designed to receive a plain language description of invention subject matter, including features, components, relationships, and operational principles. The describe your invention panel 702 may also incorporate an upload mechanism configured to accept digital files in multiple formats including but not limited to photo, video, audio, PDF, and/or DOCX, thereby enabling applicant 156 to supply both textual and multimedia disclosures for comprehensive evaluation, according to one embodiment.

The describe your invention panel 702 may channel submitted disclosure data directly into artificial intelligence engine 124 for automated parsing, semantic interpretation, and structural mapping. The artificial intelligence engine 124 may compare submitted material against specification 106, claim(s) 108, and FIG. 110 to verify alignment with patent drafting requirements. Uploaded media transmitted through the describe your invention panel 702 may additionally integrate into corpus of patent examination data 136 to support enhanced technical field 210 analysis and cross-reference validation. Output generated from the describe your invention panel 702 may directly trigger AI generated claims panel 704, according to one embodiment.

The AI generated claims panel 704 may be a dynamic output section configured to present machine-drafted claims derived from disclosure submitted through describe your invention panel 702. The AI generated claims panel 704 may display independent claim(s) and dependent claims drafted in structured legal format, each claim presented with numbering, indentation, and/or hierarchical relationships. The AI generated claims panel 704 may incorporate tracked-change formatting to highlight automated amendments, including strike-through of removed terms and underline of newly introduced terms, enabling applicant 156 to visually verify system modifications, according to one embodiment.

The AI generated claims panel 704 may operate through artificial intelligence engine 124, which may interpret plain language disclosure, uploaded files, and specification 106 material to generate claims consistent with statutory requirements under 35 U.S.C. §§ 101, 102, 103, and 112. The AI generated claims panel 704 may further incorporate citations 150 linking claim language to supporting passages within specification 106, FIG. 110, and/or authoritative reference 226. Each drafted claim within the AI generated claims panel 704 may synchronize with annotated claim set 228 for compliance evaluation and may serve as the foundation for subsequent claim amendment 402 and rationale 512 generation, according to one embodiment.

The edit 706 button may be an interactive command feature configured to enable direct modification of claims displayed within AI generated claims panel 704. The edit 706 button may be represented through a pencil icon and/or equivalent graphical symbol, indicating availability for real-time editing of automatically generated claims. The edit 706 button may provide applicant 156 with the ability to adjust claim language, restructure dependent claim relationships, and/or incorporate technical details from specification 106 and FIG. 110 disclosures, according to one embodiment.

The edit 706 button may operate in coordination with artificial intelligence engine 124 to track applicant-driven modifications. Each change submitted through the edit 706 button may be logged into annotated claim set 228, where system-level compliance checks including written description 216, antecedent basis error 220, and figure numbering consistency 218 may be re-evaluated. The edit 706 button may also trigger re-analysis against corpus of patent examination data 136 to confirm whether applicant revisions alter novelty and/or obviousness determinations relative to closest prior art 504. Outputs generated through the edit 706 button may update rationale 512 and detailed explanation 508 to ensure transparency between system-suggested amendments and applicant-specified claim edits, according to one embodiment.

The claims explanation 708 button may be a user interface feature configured to present applicant 156 with an automatically generated narrative to clarifies the legal and technical reasoning behind each AI generated claim within AI generated claims panel 704. The claims explanation 708 button may be displayed as a labeled button, upon activation, retrieves structured content from artificial intelligence engine 124. The claims explanation 708 button may provide plain language summaries to link each claim element to supporting disclosure within specification 106, FIG. 110, and/or authoritative reference 226, while also indicating distinctions over closest prior art 504, according to one embodiment.

The claims explanation 708 button may activate routines within legal reasoning engine 602 and natural language processing model 202 to generate rationale 512, indication of difference 510, and detailed explanation 508. By engaging the claims explanation 708 button, applicant 156 may access examiner-style reasoning including identification of cited prior art through citation 150 and doctrinal support derived from learned treatise 224. Outputs generated by the claims explanation 708 button may be displayed alongside annotated claim set 228 and ranked set of alternative claim amendments 144, enabling applicant 156 to evaluate proposed amendments and/or pursue arguments in response to rejection decision 506, according to one embodiment.

The save 710 button may be a user interface element configured to preserve disclosure content, AI generated claims within AI generated claims panel 704, and supporting explanatory material provided through claims explanation 708 button. The save 710 button may appear as a clearly marked button, upon activation, transmits current session data into memory 122 and storage associated with corpus of patent examination data 136. The save 710 button may ensure any progress made by applicant 156 during preparation of specification 106, claim(s) 108, and/or FIG. 110 references remains available for continued editing, review, and/or submission, according to one embodiment.

The save 710 button may operate in coordination with artificial intelligence engine 124 to store draft claim amendment 402, proposed amendment 144, annotated claim set 228, and supporting citations 150. Saved content generated through the save 710 button may later be recalled for inclusion in final output decision report 514, rejection decision 506, and/or notice of allowance 140. The save 710 button may provide applicant 156 with flexibility to pause disclosure drafting, preserve edits to generated claim language, and secure explanatory rationale 512 for future amendment review. Preservation through the save 710 button may ensure continuity across applicant interaction workflows, according to one embodiment.

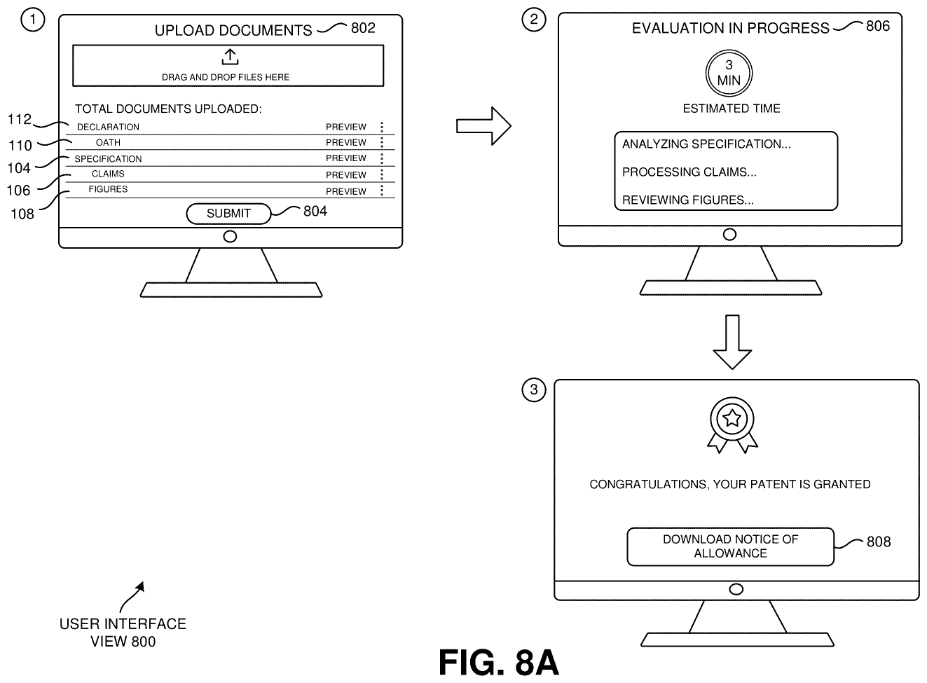

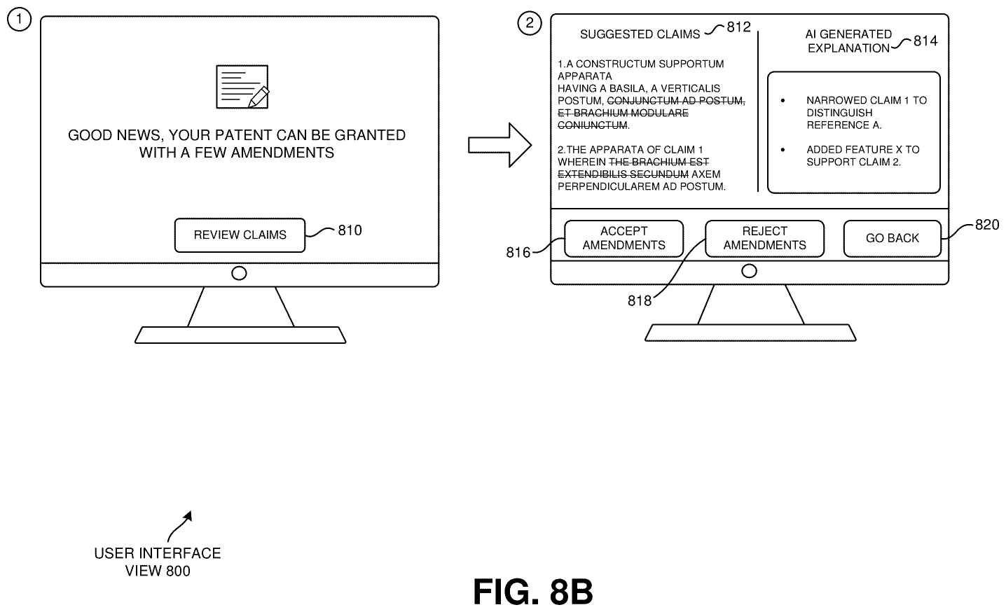

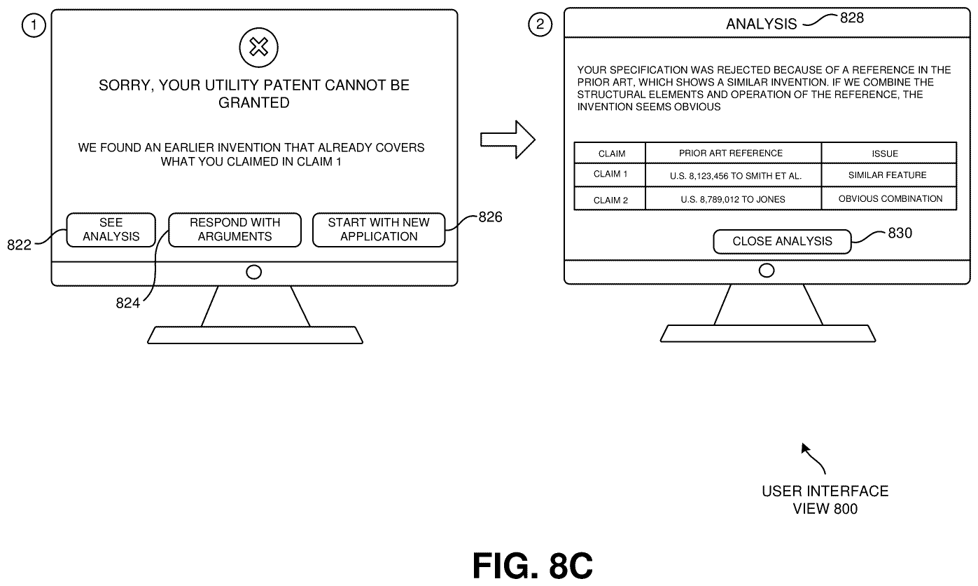

FIG. 8A is a user interface view 800 illustrating submission of a utility patent application 104 using an AI engine 124 of the computer-implemented system of FIG. 1, according to one embodiment. FIG. 8A illustrates the declaration 114, the oath 112, the specification 106, the claim(s) 108, the FIG. 110, an upload documents panel 802, a submit 804 button, an evaluation in progress panel 806, and a download notice of allowance 808 button, according to one embodiment.

Circle “1” of FIG. 8A illustrates an interaction platform of the AI engine 124 of the computer-implemented system of FIG. 1 for the applicant 156 to enable him submit the documents for filing a utility patent application 104. The upload documents panel 802 may be a user interface section structured to receive structured submissions from applicant 156, including the declaration 114, the oath 112, the specification 106, the claim(s) 106, and the FIG. 108. The upload documents panel 802 may provide a centralized location for document intake to streamline electronic submission of utility patent application components. By consolidating the submissions in one interface, the upload documents panel 802 may establish a reliable entry point into the artificial intelligence engine 124 for subsequent automated evaluation, according to one embodiment.

The upload documents panel 802 may support both drag-and-drop operations and a browse files control, thereby enabling flexible ingestion workflows for applicant 156. The upload documents panel 802 may accommodate multiple formats including but not limited to PDF, DOCX, JPEG, PNG, and MP4, ensuring textual, graphical, and multimedia disclosures may be captured. The upload documents panel 802 may further validate file integrity and structure before indexing, reducing the likelihood of incomplete submissions entering corpus of patent examination data 136, according to one embodiment.

The upload documents panel 802 may parse metadata from each submitted file, including document type, author, timestamp, and embedded headings. Parsed metadata may be mapped against corpus of patent examination data 136 to ensure consistency with prior examiner practices. The upload documents panel 802 may therefore align submissions with compliance rules enforced by statutory compliance module 126, background section 222 analysis, and written description 216 verification, according to one embodiment.

The submit 804 button may be an activation element within upload documents panel 802 configured to finalize ingestion of declaration 114, oath 112, specification 106, claim(s) 106, and FIG. 108 into artificial intelligence engine 124. The submit 804 button may operate as a trigger mechanism transitions the system from passive document collection to active statutory compliance analysis, prior art search, and claim interpretation. By engaging the submit 804 button, applicant 156 may authorize artificial intelligence engine 124 to begin automated patentability evaluation, according to one embodiment.

The submit 804 button may validate uploaded content by cross-referencing metadata from each file against expected application requirements. Validation may include ensuring specification 106 contains a background section 222, written description 216, and antecedent basis 220 consistency, while claim(s) 106 may be formatted for parsing by natural language processing model 202. Once validation may be completed, the submit 804 button may transmit structured data to corpus of patent examination data 136 for indexing, according to one embodiment.

The submit 804 button may further log applicant 156 submission activity, creating a digital audit trail. The trail may support compliance reporting, integration with the authoritative reference 226, and the evaluation progress panel 806. Activation of the submit 804 button may therefore directly initiate the evaluation in progress panel 806 and ultimately influence generation of final output decision report 514, according to one embodiment.

Circle “2” of FIG. 8A illustrates AI engine 124 of the computer-implemented system of FIG. 1 displaying the status of automated evaluation processing of the submitted documents. The evaluation in progress panel 806 may be a dynamic interface element configured to visually communicate real-time analysis of declaration 114, oath 112, specification 106, claim(s) 106, and FIG. 108 by artificial intelligence engine 124. The evaluation in progress panel 806 may present applicant 156 with transparency into each stage of automated processing, including claim parsing, statutory compliance verification, and prior art searching. The evaluation in progress panel 806 may further display estimated completion time, providing applicant 156 with predictable expectations for system output, according to one embodiment.

The evaluation in progress panel 806 may integrate data streams from natural language processing model 202, legal reasoning engine 602, and parallel/distributed computing context 604. Updates may include status indicators including “Analyzing specification 106,” “Processing claim(s) 106,” and/or “Reviewing FIG. 108,” all mapped directly to compliance requirements including subject matter eligibility 214, written description 216, figure numbering consistency 218, and antecedent basis 220. By highlighting sequential milestones, the evaluation in progress panel 806 may reduce applicant 156 uncertainty and promote trust in automated examination outcomes, according to one embodiment.

The evaluation in progress panel 806 may conclude by routing verified results to download notice of allowance 808 button and/or rejection decision 506. Completion signals from the evaluation in progress panel 806 may also be logged into final output decision report 514, providing alignment between interim updates and final determination, according to one embodiment.

Circle “3” of FIG. 8A illustrates AI engine 124 of the computer-implemented system of FIG. 1 exhibiting the allowance of patent after successful evaluation of the submitted document may be complete. The download notice of allowance 808 button may be an actionable interface element configured to deliver the formalized notice of allowance 140 generated by artificial intelligence engine 124. The download notice of allowance 808 button may provide applicant 156 with direct access to an official system-produced document indicating the claim(s) 106, specification 106, and FIG. 108 satisfy statutory requirements under 35 U.S.C. §§ 101, 102, 103, and 112. The download notice of allowance 808 button may ensure the applicant 156 receives both human-readable and machine-readable copies of the notice of allowance 140, allowing for streamlined continuation into patent office workflows, according to one embodiment.

The download notice of allowance 808 button may integrate with rationale 512, detailed explanation 508, and indication of difference 510, embedding examiner-style reasoning into the downloadable document. The download notice of allowance 808 button may also incorporate citation 150 to prior art 504 and annotated claim set 228, providing applicant 156 with a transparent record of how the final determination was reached, according to one embodiment.

The download notice of allowance 808 button may act as a transition gateway within user interface view 800, signaling completion of evaluation in progress panel 806. Activation of the download notice of allowance 808 button may further log a confirmation entry into final output decision report 514, ensuring end-to-end traceability of allowance communication, according to one embodiment.

FIG. 8B is a user interface view 800 illustrating amendments with suggested claims 812, and AI generated explanation 814 using an AI engine 124 of the computer-implemented system of FIG. 1, according to one embodiment. FIG. 8B illustrates a review claims 810 button, a suggested claims panel 812, an AI generated explanation panel 814, a accept amendment 816 button, an reject amendments 818 button, and a go back 820 button, according to one embodiment.

Circle “1” of FIG. 8B illustrates a user interface of the AI engine 124 of the computer-implemented system of FIG. 1 displaying the potential allowance of the patent after compliance with suggested amendments. The review claims 810 button may be an interactive user interface mechanism configured to guide applicant 156 from a conditional allowance notification into a structured amendment review environment. The review claims 810 button may serve as the primary gateway for applicant 156 to access claim analysis generated by artificial intelligence engine 124. The review claims 810 button may present applicant 156 with an actionable option initiates transition from a summary-level outcome screen into suggested claims panel 812 and AI generated explanation panel 814, according to one embodiment.

The review claims 810 button may establish a direct link between initial conditional allowance outputs and subsequent amendment evaluation workflows. The review claims 810 button may display status indicators confirming the claim(s) 106 have been parsed, modifications have been tracked, and statutory compliance checks under §§ 102, 103, and 112 have been applied. Once activated, the review claims 810 button may trigger population of suggested claims panel 812 with annotated claim set 228, including strike-through deletions and underlined additions, according to one embodiment.

The review claims 810 button may further record applicant 156 interaction into final output decision report 514. Logging may include timestamps, amendment selections, and/or navigation pathways, ensuring accountability, auditability, and traceability for downstream review by applicant 156 and/or examiner systems, according to one embodiment.

Circle “2” of FIG. 8B illustrates a user interface of the AI engine 124 of the computer-implemented system of FIG. 1 displaying the proposed amendment 144 suggested by the AI engine 124. The suggested claims panel 812 may be a dedicated interface workspace configured to display AI-generated modifications to claim(s) 106. The suggested claims panel 812 may organize amendments into a structured format to highlights textual differences through strike-through deletions and underlined additions. The suggested claims panel 812 may incorporate the annotated claim set 228, enabling the applicant 156 to evaluate modifications in the same style as examiner-tracked amendments, according to one embodiment.

The suggested claims panel 812 may receive inputs directly from artificial intelligence engine 124, which evaluates novelty under § 102, obviousness under § 103, and written description sufficiency under § 112. The suggested claims panel 812 may further reflect results of comparison against closest prior art 504, with proposed refinements designed to distinguish over cited references. Each claim entry displayed within suggested claims panel 812 may expand into a detailed view, showing both the proposed redlined claim text and supporting rationale 512, according to one embodiment.

The suggested claims panel 812 may operate in tandem with AI generated explanation panel 814. Together, both panels may guide applicant 156 toward accepting, rejecting, and/or requesting alternatives to claim amendment 402. Interaction performed within suggested claims panel 812 may be logged into final output decision report 514 for downstream submission, according to one embodiment.

The AI generated explanation 814 may be a structured interface section configured to present narrative reasoning produced by artificial intelligence engine 124. The AI generated explanation 814 may display clear textual summaries explaining why specific amendments within the suggested claims panel 812 recommended. The AI generated explanation 814 may align with examiner-style guidance by referencing standards under §§ 102, 103, and 112, ensuring the applicant 156 receives transparent reasoning comparable to traditional office actions, according to one embodiment.

The AI generated explanation 814 may integrate references to closest prior art 504, authoritative reference 226, and learned treatise 224. The AI generated explanation 814 may further include direct linkage to rationale 512 and indication of difference 510, thereby demonstrating how individual claim limitations were evaluated against retrieved prior art. Explanations within AI generated explanation 814 may highlight legal justifications, technical distinctions, and compliance considerations in a format accessible to both legally trained professionals and non-specialist inventors, according to one embodiment.

The AI generated explanation 814 may also support applicant interaction by providing plain-English explanations in parallel with legal citations. The dual presentation may enhance applicant comprehension while maintaining procedural consistency, and any explanatory content from AI generated explanation 814 may be consolidated into final output decision report 514, according to one embodiment.

The accept amendments 816 button may be an interface element configured to enable applicant 156 to formally adopt modifications displayed within suggested claims panel 812. The accept amendments 816 button may finalize proposed claim amendment 402, rewrite dependent claim 502, and ranked set of alternative claim amendments 144 into a binding submission for continued prosecution. Activation of the accept amendments 816 button may signal artificial intelligence engine 124 to incorporate adopted claim language into annotated claim set 228, ensuring precise alignment with specification 106 and FIG. 110, according to one embodiment.

The accept amendments 816 button may further generate a consolidated record within final output decision report 514, documenting the applicant's consent to proceed with amended claims. The record may include supporting rationale 512, indication of difference 510, and citation 150 to prior art, thereby preserving examiner-style transparency. Acceptance through the accept amendments 816 button may trigger issuance of notice of allowance 140 when patentability requirements under §§ 102, 103, and 112 may be satisfied. The accept amendments 816 button may therefore function as a procedural gateway allowing applicant 156 to move directly toward allowance following conditional examination outcomes, according to one embodiment.

The reject amendments 818 button may be an interface element configured to provide applicant 156 with the ability to decline adoption of proposed claim amendment 402, rewrite dependent claim 502, and/or ranked set of alternative claim amendments 144. Engagement of the reject amendments 818 button may preserve the originally submitted claim(s) 106 without modification, while transferring examination status into a rejection pathway. The rejection pathway may include generation of written rejection 142 supported by closest prior art 504, rationale 512, and detailed explanation 508, according to one embodiment.

The reject amendments 818 button may connect directly with respond with arguments option, allowing applicant 156 to draft legal reasoning and/or factual rebuttals. Traceability of rejection choice through reject amendments 818 button may be captured within final output decision report 514, enabling examiner-style workflow replication. The reject amendments 818 button may additionally trigger parallel creation of annotated claim set 228 to display side-by-side differences between unmodified claim(s) 106 and proposed claim amendment 402, ensuring clarity of applicant's decision. Through the pathway, the reject amendments 818 button may support applicant 156 in maintaining original claim scope while preserving the right to contest novelty and/or obviousness rejections under §§ 102 and/or 103, according to one embodiment.

The go back 820 button may be an interface element configured to return applicant 156 from suggested claims panel 812 to the preceding decision hub without committing to acceptance and/or rejection. The go back 820 button may preserve session continuity by maintaining temporary states of claim amendment 402, ranked set of alternative claim amendments 144, and annotated claim set 228. The preservation may ensure the applicant 156 can re-enter suggested claims panel 812 without data loss, according to one embodiment.

The go back 820 button may interact with artificial intelligence engine 124 to refresh contextual links between claim(s) 106, specification 106, and closest prior art 504. Through the interaction, the go back 820 button may enable recalculation of probability of allowance 154 and quantified confidence score 152 when alternative pathways may be reconsidered. Execution of the go back 820 button may also trigger regeneration of rationale 512 and indication of difference 510, ensuring alignment with updated review choices, according to one embodiment.

The go back 820 button may therefore function as a navigational safeguard, allowing applicant 156 to reconsider notice of allowance 140, rejection decision 506, and/or proposed amendment 402 before finalizing selection within final output decision report 514, according to one embodiment.

FIG. 8C is a user interface view 800 illustrating a rejection notification and an analysis 828 of claims with prior art references using the AI engine 124 of the computer-implemented system of FIG. 1, according to one embodiment. FIG. 8C illustrates a see analysis 822 button, a respond with arguments 824 button, a start with new application 826 button, an analysis panel 828, and a close analysis 830 button, according to one embodiment.

Circle “1” of FIG. 8C illustrates a user interface of the AI engine 124 of the computer-implemented system of FIG. 1 displaying the rejection notification based on the analysis using the AI engine 124. The see analysis 822 button may be a user interface element configured to allow applicant 156 to transition from a rejection notification page into a detailed evaluation workspace. The see analysis 822 button may be rendered as a button and/or interactive element designed to explicitly signal availability of deeper reasoning underlying rejection decision 506. The see analysis 822 button may provide applicant 156 with structured access to prior art references, claim mappings, and statutory bases evaluated by artificial intelligence engine 124, according to one embodiment.

Circle “2” of FIG. 8C illustrates a user interface of the AI engine 124 of the computer-implemented system of FIG. 1 displaying the analysis using the AI engine 124 led to the rejection of the patent application. The see analysis 822 button may function as a gateway to analysis panel 828. The see analysis 822 button may transmit claim(s) 106, limitation mappings derived from natural language processing model 202, and links to citations 150. The see analysis 822 button may further connect to closest prior art 504 and route explanatory content from rationale 512 and detailed explanation 508, enabling side-by-side comparison of claim language with reference disclosures. The see analysis 822 button may also generate interaction logs become part of final output decision report 514, supporting procedural transparency, according to one embodiment.

The rejection notification page may precede activation of the see analysis 822 button, presenting plain-language summaries including “An earlier invention already covers claim 1” and/or “Claim 2 would be obvious by combining Reference A with Reference B.” The rejection notification page may direct applicant 156 to next-step options, including the see analysis 822 button, respond with arguments 824 button, and/or start with new application 826 button, ensuring seamless transition from rejection decision 506 toward remedial action, according to one embodiment.

The respond with arguments 824 button may be an interactive interface element configured to open a dedicated argument-drafting workspace following presentation of the rejection notification page. The respond with arguments 824 button may activate once applicant 156 selects an option to challenge rejection decision 506, enabling direct engagement with claim(s) 106 and supporting references identified during automated prior art search 306. The respond with arguments 824 button may integrate structured input templates for applicant 156 to construct arguments in a manner consistent with examiner practice, according to one embodiment.

The respond with arguments 824 button may synchronize with detailed explanation 508, rationale 512, and indication of difference 510, ensuring each applicant statement corresponds with identified limitations and cited references. The argument-drafting workspace generated by the respond with arguments 824 button may provide side-by-side access to closest prior art 504, citations 150, and annotated claim set 228, thereby grounding arguments in both factual and legal distinctions, according to one embodiment.

Through the respond with arguments 824 button, applicant 156 may prepare submissions referencing statutory bases under 35 U.S.C. §§ 102, 103, and 112, aligning responses with procedural standards. The argument-drafting workspace may allow applicant 156 to either finalize arguments for submission and/or request generation of additional alternative claim amendments 144, according to one embodiment.

The start with new application 826 button may be a procedural interface option configured to reset the examination pathway when rejection decision 506 determines the claim(s) 106 may not advance toward allowance. The start with new application 826 button may provide applicant 156 with a direct mechanism to initiate preparation of a revised utility patent application to addresses deficiencies revealed by closest prior art 504, rationale 512, and detailed explanation 508, according to one embodiment.

The start with new application 826 button may present applicant 156 with an input workspace pre-populated with disclosure elements including specification 106, FIG. 108, claim amendment 402, and suggested claims generated during prior review through annotated claim set 228. By leveraging previously analyzed disclosure, the start with new application 826 button may reduce redundancy and streamline the drafting of a modified submission. The start with new application 826 button may also provide access to compliance guidance referencing subject matter eligibility 214, written description 216, and antecedent basis errors 220, ensuring alignment with statutory requirements from the outset of the new filing, according to one embodiment.

The start with new application 826 button may log procedural transition into final output decision report 514 to preserve traceability across examination cycles. The start with new application 826 button may therefore create a bridge from rejection notification page into a renewed submission cycle supported by artificial intelligence engine 124, according to one embodiment.

The analysis panel 828 may be a structured interface generated by artificial intelligence engine 124 to provide applicant 156 with a clear comparison between claim(s) 106 and closest prior art 504. The analysis panel 828 may organize content into a tabular and/or card-based format, displaying distinct columns labeled “Claim,” “Prior-art reference,” and “Issue.” Each row may correspond to a given claim, allowing applicant 156 to see a one-to-one mapping of claim limitations against cited disclosures, according to one embodiment.

The analysis panel 828 may embed citation 150 for traceability, along with direct excerpts from prior art sources. Hyperlinked entries may connect to authoritative reference 226 and learned treatise 224, providing applicant 156 with doctrinal support and examiner-style reasoning. The analysis panel 828 may further incorporate indication of difference 510, using visual markers to highlight limitations missing from prior art and/or rationales supporting combinations under 35 U.S.C. § 103, according to one embodiment.

The analysis panel 828 may synchronize dynamically with rejection decision 506, rationale 512, and detailed explanation 508, ensuring consistency across all statutory determinations. Engagement within the analysis panel 828 may be logged into final output decision report 514 for recordkeeping and for guiding potential responses, including claim amendment 402 and/or applicant arguments 408, according to one embodiment.

The close analysis 830 button may be an interface element configured to exit the analysis panel 828 and return applicant 156 to the rejection notification page. The close analysis 830 button may maintain continuity by preserving scroll position, applied filters, and claim-to-reference alignment established during review. The design may allow applicant 156 to navigate between the analysis panel 828 and the rejection notification page without duplicating effort and/or losing context, ensuring efficiency in reviewing rejection decision 506, according to one embodiment.

The close analysis 830 button may further perform backend logging of session metadata, including timestamps, claims reviewed, and references accessed. The session metadata may be stored within final output decision report 514, providing a complete audit trail of applicant interaction with analysis functions. The logged data may support examiner-style transparency by demonstrating how claim(s) 106 were evaluated against closest prior art 504, citations 150, and indication of difference 510, according to one embodiment.

The close analysis 830 button may additionally trigger a guided prompt inviting applicant 156 to select next procedural steps, including respond with arguments 824 button and/or start with new application 826 button. The process may ensure the applicant 156 receives clear direction for continuing examination in alignment with rationale 512 and detailed explanation 508, according to one embodiment.

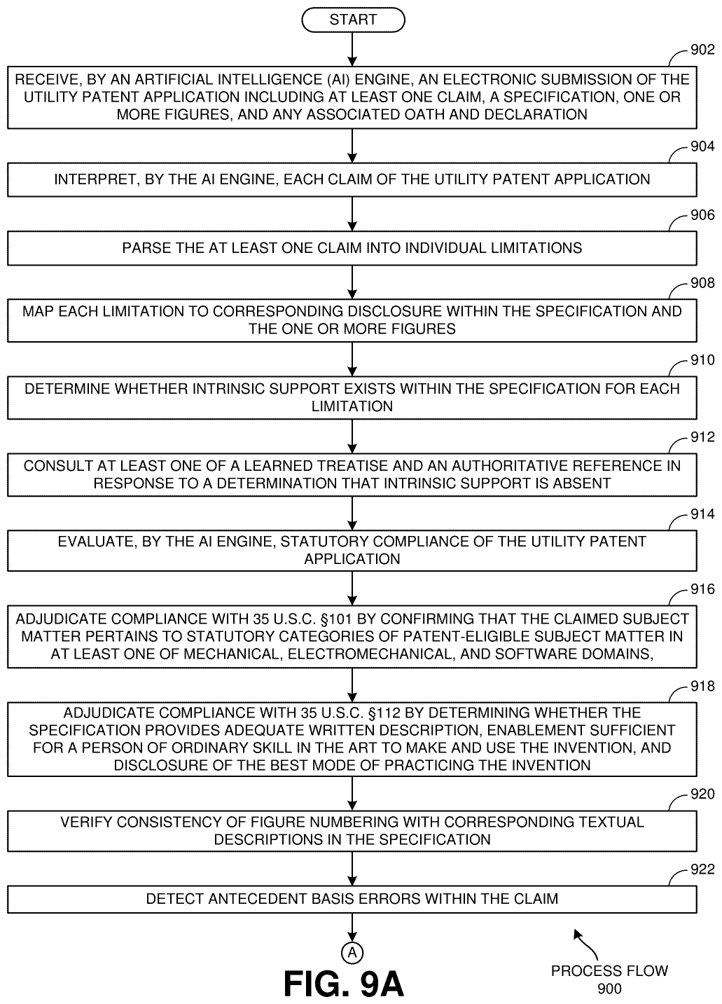

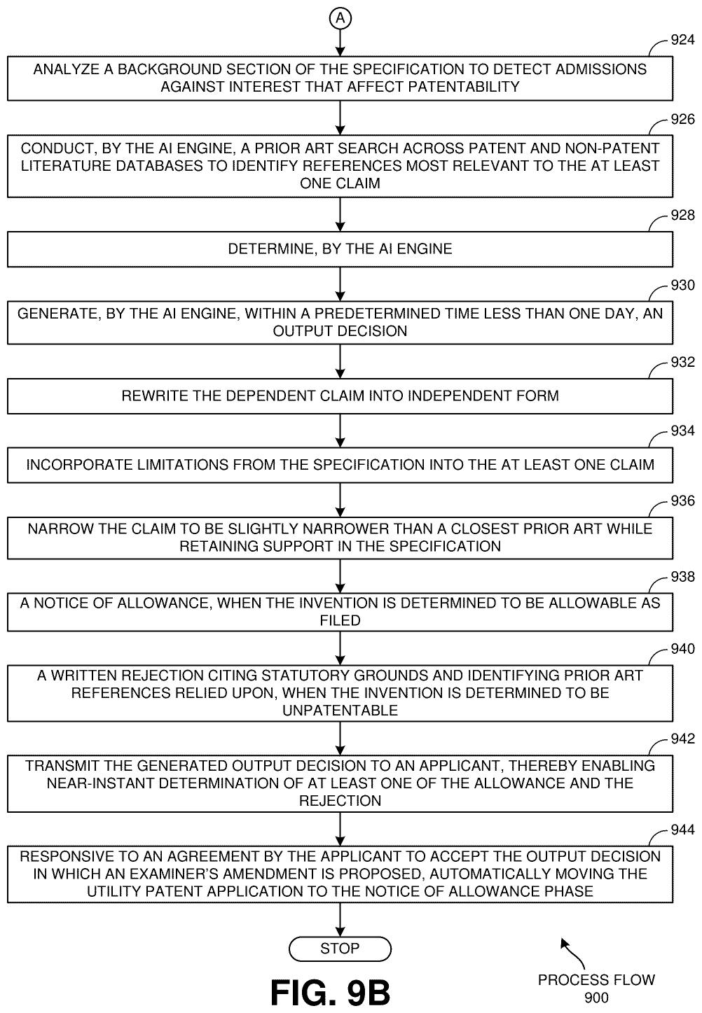

FIG. 9A-B is a process flow diagram 900 of the computer-implemented system of FIG. 1 illustrating patent examination workflow to evaluate compliance of a utility patent application 104, according to one embodiment.

In operation 902, the artificial intelligence engine 124 may receive an electronic submission of the utility patent application including claim(s) 106, specification 106, FIG. 108, oath 112, and declaration 114, according to one embodiment. In operation 904, the artificial intelligence engine 124 may interpret each claim 106 of the utility patent application, according to one embodiment. In operation 906, the artificial intelligence engine 124 may parse claim(s) 106 into individual limitations. In operation 908, the artificial intelligence engine 124 may map each limitation to corresponding disclosure within the specification 106 and the FIG. 108, according to one embodiment.

In operation 910, the artificial intelligence engine 124 may determine whether intrinsic support exists within specification 106 (and/or the figures) for each limitation. In operation 912, the artificial intelligence engine 124 may consult learned treatise 224 and authoritative reference 226 in response to a determination intrinsic support may be absent. In operation 914, the artificial intelligence engine 124 may evaluate statutory compliance of the utility patent application 104. In operation 916, the artificial intelligence engine 124 may adjudicate compliance with 35 U.S.C. § 101 by confirming to the claimed subject matter pertains to statutory categories of patent-eligible subject matter in mechanical, electromechanical, chemical, electrical, pharmaceutical, consumer, and software domains, according one embodiment.

In operation 918, the artificial intelligence engine 124 may adjudicate compliance with 35 U.S.C. § 112 by determining whether specification 106 provides adequate written description, enablement, and disclosure of the best mode of practicing the invention. In operation 920, the artificial intelligence engine 124 may verify consistency of figure numbering in FIG. 108 with corresponding textual descriptions in specification 106. In operation 922, the artificial intelligence engine 124 may detect antecedent basis errors within claim(s) 106, according to one embodiment.

In operation 924, the artificial intelligence engine 124 may analyze background section 222 of specification 106 to detect admissions against interest to affect patentability. In operation 926, the artificial intelligence engine 124 may conduct a prior art search across searchable databases 134 including patent and non-patent literature to identify references most relevant to claim(s) 106. In operation 928, the artificial intelligence engine 124 may determine novelty and obviousness of claim(s) 106 based on identified references, according to one embodiment.

In operation 930, the artificial intelligence engine 124 may generate output decision 138 within a predetermined time less than one day (preferably within minutes). In operation 932, the artificial intelligence engine 124 may rewrite dependent claim 502 into independent form. In operation 934, the artificial intelligence engine 124 may incorporate limitations from specification 106 into claim(s) 106. In operation 936, the artificial intelligence engine 124 may narrow claim(s) 106 to be slightly narrower than closest prior art 504 while retaining support in specification 106. In operation 938, the artificial intelligence engine 124 may generate notice of allowance 140 when invention may be determined to be allowable as filed, according to one embodiment.

In operation 940, the artificial intelligence engine 124 may generate rejection decision 506 citing statutory grounds and identifying prior art references when invention may determined to be unpatentable. In operation 942, the artificial intelligence engine 124 may transmit output decision 138 to applicant 156, enabling near-instant determination of allowance and/or rejection. In operation 944, the artificial intelligence engine 124 may, responsive to agreement by applicant 156 to accept output decision 138 including examiner's amendment, automatically move electronic submission 102 of utility patent application into notice of allowance 140 phase, according to one embodiment.

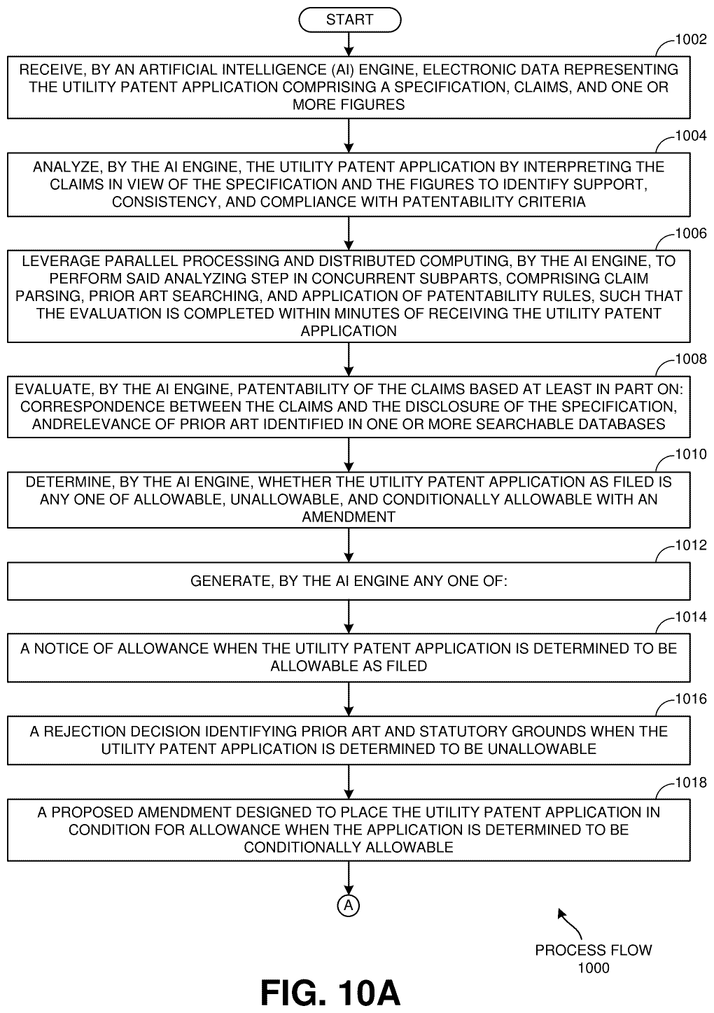

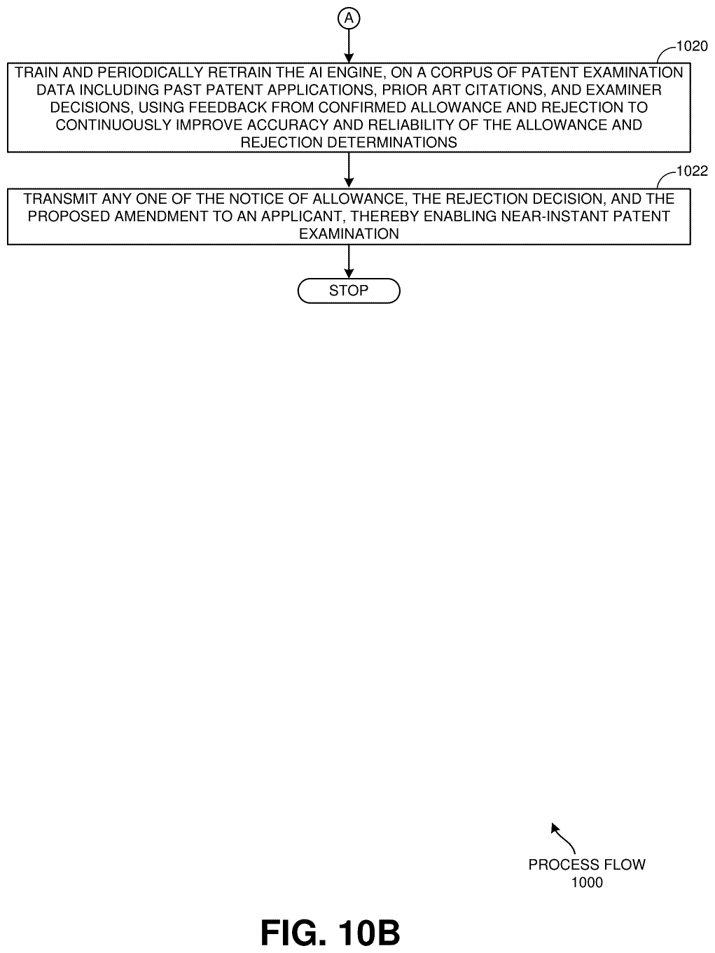

FIG. 10A-B is a process flow diagram 1000 of the computer-implemented system of FIG. 1 illustrating evaluation and decision-generation workflow of a utility patent application 104, according to one embodiment.

In operation 1002, the artificial intelligence engine 124 may receive electronic submission 102 of utility patent application comprising specification 106, claim(s) 106, and FIG. 110. In operation 1004, the artificial intelligence engine 124 may analyze utility patent application by interpreting claim(s) 106 in view of specification 106 and FIG. 110 to identify support, consistency, and compliance with patentability criteria, according to one embodiment.

In operation 1006, the artificial intelligence engine 124 may leverage parallel/distributed computing context 604 to perform claim parsing, prior art searching, and application of patentability rules concurrently, the evaluation may be completed within minutes. In operation 1008, the artificial intelligence engine 124 may evaluate patentability of claim(s) 106 based at least in part on correspondence between claim(s) 106 and specification 106 and relevance of prior art identified in searchable databases 134. In operation 1010, the artificial intelligence engine 124 may determine whether utility patent application as filed may be allowable, unallowable, and/or conditionally allowable with claim amendment 402, according to one embodiment.

In operation 1012, the artificial intelligence engine 124 may generate output decision 138 comprising one of: In operation 1014, the notice of allowance 140 when utility patent application may be determined allowable as filed. In operation 1016, the rejection decision 506 identifying closest prior art 504 and statutory grounds when utility patent application may be determined unallowable. In operation 1018, the proposed claim amendment 402 designed to place utility patent application in condition for allowance when application may be determined conditionally allowable, according to one embodiment.

In operation 1020, the artificial intelligence engine 124 may be trained and periodically retrained on corpus of patent examination data 136 including past patent applications, prior art citations, and examiner decisions, using feedback from confirmed allowances/rejections 610 to continuously improve accuracy and reliability of allowance and rejection determinations. In operation 1022, the artificial intelligence engine 124 may transmit notice of allowance 140, rejection decision 506, and/or proposed claim amendment 402 to applicant 156, thereby enabling near-instant patent examination, according to one embodiment.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, and/or sequential order, to achieve desirable results. In addition, other steps may be provided, and/or steps may be eliminated, from the described flows, and other components may be added to, and/or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A computer-implemented method of near-instant evaluation of a utility patent application, the method comprising:
receiving, by an artificial intelligence (AI) engine, an electronic submission of the utility patent application including at least one claim, a specification, one or more figures, and any associated oath and declaration;
interpreting, using the AI engine, each claim of the utility patent application by:
parsing the at least one claim into individual limitations,
mapping each limitation to corresponding disclosure within at least one of the specification and the one or more figures,
determining whether intrinsic support exists in at least one of of the specification and the figures for each limitation, and
consulting at least one of a learned treatise and an authoritative reference in response to a determination that either intrinsic support is insufficient;
evaluating, using the AI engine, statutory compliance of the utility patent application, including:
adjudicating compliance with 35 U.S.C. § 101 by confirming that the claimed subject matter pertains to statutory categories of patent-eligible subject matter in at least one of mechanical, electromechanical, chemical, electrical, pharmaceutical, consumer, and software domains,
adjudicating compliance with 35 U.S.C. § 112 by determining whether the specification provides adequate written description, enablement sufficient for a person of ordinary skill in the art to make and use the at least one claim and disclosure of the best mode of practicing the at least one claim,
verifying consistency of figure numbering with corresponding textual descriptions in the specification,
detecting antecedent basis errors within the at least one claim, and
analyzing a background section of the specification to detect admissions against interest that affect patentability of the at least one claim;
conducting, using the AI engine, a prior art search across patent and non-patent literature databases to identify disclosure in references most relevant to the at least one claim;
determining, using the AI engine:
whether disclosure in a single prior art reference anticipates the at least one claim under 35 U.S.C. § 102,
whether disclosure in combinations of prior art references render the at least one claim obvious under 35 U.S.C. § 103, comprising through simulated claim construction and application of examiner guidelines from the Manual of Patent Examining Procedure (MPEP), and
whether at least one dependent claim contains limitations capable of being amended into independent form to overcome a potential rejection;
generating, using the AI engine, within a predetermined time preferably within minutes, an output decision, comprising:
an amendment proposing changes to the at least one claim, figures, and the specification designed to place the utility patent application in condition for allowance, when at least one claim is determined to be patentable with the amendment, and responsive to at least one of a suggested acceptance of:
rewriting a dependent claim into independent form,
incorporating limitations from the specification into the at least one claim, and
narrowing the claim to be slightly narrower than a closest prior art while retaining support in the specification; and
a notice of allowance, when the at least one claim is determined to be allowable as filed, and
a written rejection citing statutory grounds and identifying prior art references relied upon, when the at least one claim is determined to be unpatentable;
transmitting the generated output decision to an applicant, thereby enabling near-instant determination of at least one of the allowance and the rejection; and
responsive to an agreement by the applicant to accept the output decision in which an examiner's amendment is proposed, automatically moving the utility patent application to the notice of allowance phase.

2. The computer-implemented method for near-instant evaluation of the utility patent application for at least one of the allowance and the rejection of claim 1, wherein the proposed examiner's amendment automatically resolves antecedent basis errors by introducing proper referencing terms.

3. The computer-implemented method for near-instant evaluation of the utility patent application for at least one of the allowance and the rejection of claim 1, wherein the AI engine selects the dependent claim that includes non-obvious subject matter, and rewrites it into independent form to achieve allowance.

4. The computer-implemented method for near-instant evaluation of the utility patent application for at least one of the allowance and the rejection of claim 1, wherein the AI engine generates an annotated claim set displaying tracked changes, with inline references to supporting paragraphs in the specification.

5. The computer-implemented method for near-instant evaluation of the utility patent application for at least one of the allowance and the rejection of claim 1, wherein the AI engine proactively generates multiple alternative amendments, ranked by statistical confidence in allowability, for applicant selection.

6. The computer-implemented method for near-instant evaluation of the utility patent application for at least one of the allowance and the rejection of claim 1, wherein the proposed examiner's amendment is designed to be just narrow enough to distinguish over the closest prior art, preserving maximum claim scope while placing the case in condition for the allowance.

7. The computer-implemented method for near-instant evaluation of the utility patent application for at least one of the allowance and the rejection of claim 1, wherein upon rejection, the AI engine proposes both a claim amendment option and a written rejection option, enabling the applicant to choose between acceptance of amendment for the allowance or submission of arguments in response.

8. The computer-implemented method for near-instant evaluation of the utility patent application for at least one of the allowance and the rejection of claim 1, wherein analyzing the utility patent application comprises performing automated claim construction by using a natural language processing model to parse the claims and identify individual claim elements, determining the scope and meaning of each claim term based on a context provided by the specification and domain-specific definitions.

9. The computer-implemented method for near-instant evaluation of the utility patent application for at least one of the allowance and the rejection of claim 8, wherein the AI engine evaluates compliance with disclosure requirements by confirming that each claimed feature has corresponding support in the specification, thereby checking for enablement and written description sufficiency for the claims.

10. The computer-implemented method for near-instant evaluation of the utility patent application for at least one of the allowance and the rejection of claim 9, wherein the AI engine utilizes at least one of domain-specific knowledge bases and models during analysis, including models trained for mechanical and electromechanical inventions and models trained for software-related inventions, and automatically selects at least one of an appropriate model and knowledge base based on a technical field of the utility patent application to improve the accuracy of claim interpretation and prior art relevance.

11. The computer-implemented method for near-instant evaluation of the utility patent application for at least one of the allowance and the rejection of claim 1,
wherein analyzing the patent application further comprises performing an automated prior art search by querying one or more patent and technical literature databases using at least one of keywords, semantic queries, and extracted features from the at least one claim and the specification, to retrieve relevant prior art references without human intervention, and
wherein the AI engine evaluates novelty of each claim by comparing the claim elements against the retrieved prior art references and determining whether disclosure in a single prior art reference discloses all of the elements of a given claim, indicating a lack of novelty if such a reference is found.

12. The computer-implemented method for near-instant evaluation of the utility patent application for at least one of the allowance and the rejection of claim 1,
wherein the AI engine evaluates non-obviousness by, in response to finding no single reference that anticipates the claim, identifying combinations of two or more prior art references that collectively teach all elements of the claim and assessing whether the person of ordinary skill in the art would have been motivated to combine those references to arrive at the at least one claim, and
wherein the analysis applies patent examination guidelines for obviousness determinations, including analyzing the differences between the at least one claim and the prior art, considering the level of ordinary skill in the pertinent art, and applying established rationales to determine if there is an apparent motivation to combine the prior art teachings, thereby ensuring the obviousness evaluation is consistent with examiner standards.

13. The computer-implemented method for near-instant evaluation of the utility patent application for at least one of the allowance and the rejection of claim 1, wherein analyzing the utility patent application includes processing any submitted figures using computer vision techniques to identify at least one depicted component and process steps, and correlating those identified elements with the claim elements and prior art references to enhance the accuracy of the novelty and obviousness analysis for mechanical and electromechanical inventions.

14. The computer-implemented method for near-instant evaluation of the utility patent application for at least one of the allowance and the rejection of claim 1, wherein the output decision is accompanied by a detailed explanation generated by the AI engine, the explanation including citations to the relevant prior art references for each claim limitation, an indication of any differences between the claimed invention and the prior art, and a rationale for at least one recommended allowance and rejection of each claim.

15. The computer-implemented method for near-instant evaluation of the utility patent application for at least one of the allowance and the rejection of claim 1, wherein the AI engine leverages parallel processing and distributed computing to perform the analyzing step in subparts concurrently including claim parsing, prior art searching, and patentability rule application, such that the patentability determination is completed within minutes of receiving the utility patent application, thereby achieving near-instant examination.

16. The computer-implemented method for near-instant evaluation of the utility patent application for at least one of the allowance and the rejection of claim 1, wherein the AI engine comprises a legal reasoning engine, the legal reasoning engine is trained on a corpus of patent examination data comprising past patent applications, prior art citations, and examiner decisions, and is periodically retrained using feedback from confirmed allowances and rejections, thereby continuously improving the accuracy and reliability of its at least one of allowance and rejection determinations over time.

17. A computer-implemented method of near-instant evaluation of a utility patent application, comprising:
analyzing, using an artificial intelligence (AI) engine the utility patent application by interpreting the claims in view of the specification and the figures to identify support, consistency, and compliance with patentability criteria;
evaluating, using the AI engine, patentability of the claims based at least in part on:
correspondence between the claims and the disclosure of the specification, and
relevance of prior art identified in one or more searchable databases;
determining, using the AI engine, whether a claim of the utility patent application is any one of allowable, unallowable, and conditionally allowable with an amendment; and
generating within minutes of using the AI engine to analyze the utility patent application any one of:
a notice of allowance when the utility patent application is determined to be allowable as filed,
a rejection decision identifying prior art and statutory grounds when the utility patent application is determined to be unallowable, and
a proposed amendment designed to place the utility patent application in condition for allowance when the application is determined to be conditionally allowable.

18. The computer-implemented method for near-instant evaluation of the utility patent application of claim 17, further comprising:
training the AI engine, on a corpus of patent examination data including past patent applications, prior art citations, and examiner decisions, using feedback from confirmed allowance and final rejection decisions to continuously improve accuracy and reliability of the allowance and rejection determinations; and
transmitting any one of the notice of allowance, the rejection decision, and the proposed amendment to an applicant, thereby enabling near-instant patent examination,
wherein the proposed amendment generated by the AI engine comprises a ranked set of alternative claim amendments, each alternative accompanied by: (i) citations to specific supporting passages in the specification, (ii) an identification of the closest prior art reference distinguished by the amendment, and (iii) a quantified confidence score representing a probability of allowance if the amendment is adopted.

19. A system for near-instant evaluation of a utility patent application, comprising:
a processor;
a memory storing executable instructions that, when executed by the processor, configure the system to perform operations comprising:
receiving, by an artificial intelligence (AI) engine, electronic data representing a utility patent application including a specification, at least one claim, and one or more figures,
analyzing the utility patent application by interpreting the claims in view of the specification and the figures to identify support, consistency, and compliance with patentability criteria,
leveraging parallel processing and distributed computing to perform said analyzing in concurrent subparts, including claim parsing, prior art searching, and application of patentability rules, such that evaluation is completed within minutes of receiving the utility patent application;
evaluating patentability of the claims based at least in part on:
correspondence between the claims and the disclosure of the specification, and
relevance of prior art identified in one or more searchable databases;
determining whether the utility patent application as filed is any one of allowable, unallowable, and conditionally allowable with amendment;
generating any one of:
a notice of allowance when the utility patent application is determined to be allowable as filed,
a rejection decision identifying prior art and statutory grounds when the utility patent application is determined to be unallowable, and
a proposed amendment designed to place the utility patent application in condition for allowance when the application is determined to be conditionally allowable.

20. The system for near-instant evaluation of a utility patent application of claim 19, wherein the proposed amendment generated by the AI engine includes a ranked set of alternative claim amendments, each alternative accompanied by: (i) citations to specific supporting passages in the specification, (ii) an identification of the closest prior art reference distinguished by the amendment, and (iii) a quantified confidence score representing a probability of allowance if the amendment is adopted.
